(19) United States
(12) Patent Application Publication
(10) Pub. No.: US 2015/0258721 A1
(43) Pub. Date: Sep. 17, 2015

(54) Plastic Article Forming Apparatuses and Methods for Using the Same

(71) Applicant: iMFLUX Inc., Cincinnati, OH (US)

(72) Inventors: Charles John BERG, JR., Wyoming, OH (US); Douglas Bruce ZEIK, Liberty Twp, OH (US); Gene Michael ALTONEN, West Chester, OH (US); Chow-chi HUANG, West Chester, OH (US); Michael Thomas DODD, Walton, KY (US); Ralph Edwin NEUFARTH, Liberty Twp., OH (US)

(21) Appl. No.: 14/656,050

(22) Filed: Mar. 12, 2015

Related U.S. Application Data
(60) Provisional application No. 61/952,283, filed on Mar. 13, 2014.

(51) Int. Cl. B29C 45/76; B29D 22/00

(52) U.S. Cl. CPC B29C 45/7626; B29D 22/003; B29L 2031/7158

(57) ABSTRACT

A system for forming a plastic article, the system comprising a preform injection molding apparatus, comprising a mold, a plastic melt injection system, a sensor, and a controller, wherein: the first mold portion is made of a material having a thermal conductivity between about 52 watts per meter kelvin and about 385 watts per meter kelvin; the controller is configured to control the injection element to maintain the molten thermoplastic material at a substantially constant melt pressure, during filling of the mold cavities, wherein the substantially constant melt pressure is between about 2.76 megapascals (400 psi) and about 68.95 megapascals (10,000 psi); and the preform injection molding apparatus is designed to have a useful life of between one million and ten million injection molding cycles.

### TECHNICAL FIELD

The present disclosure relates to plastic article forming apparatuses and methods of producing plastic articles and, more particularly, to substantially constant low pressure injection molding apparatuses and methods for producing plastic articles from preforms formed at substantially constant low injection pressures.

### BACKGROUND

Plastic articles, such as plastic bottles, containers, caps, and the like can be made using a number of techniques, depending on the requirements of the plastic article. Plastic articles may be made using multiple techniques if, for example, different materials are used or different functions are required. For example, bottles may be made using an injection blow molding process, which may include a stretching stage, or another manufacturing process. In some of these processes, the final plastic article, or final product, is blow molded from a parison, or a preform. The preform may be formed by injection molding, for example. Once formed, the preform may be removed from the mold cavity and transported to a blow molding apparatus to be blow molded to form the final plastic article. In some processes, the preform may be stretched or elongated prior to or during the blow molding process. Because the final plastic article is formed from the preform, internal and external stresses within the preform may affect the overall quality of the final plastic article. Further, in mass production, the preform may directly affect the yield of the final plastic article, and the preform forming process may directly affect the costs and speed of production of the final plastic article.

### BRIEF DESCRIPTION OF THE DRAWINGS

The embodiments set forth in the drawings are illustrative in nature and not intended to limit the subject matter defined by the claims. The following detailed description of the illustrative embodiments can be understood when read in conjunction with the following drawings, where like structure is indicated with like reference numerals and in which:

FIG. 1 illustrates a schematic view of one embodiment of a substantially constant low injection pressure molding machine constructed according to the disclosure;

FIG. 2 is a cavity pressure vs. time graph for the substantially constant low injection pressure molding machine of FIG. 1 superimposed over a cavity pressure vs. time graph for a conventional high variable pressure injection molding machine;

FIG. 3 is another cavity pressure vs. time graph for the substantially constant low injection pressure molding machine of FIG. 1 superimposed over a cavity pressure vs. time graph for a conventional high variable pressure injection molding machine, the graphs illustrating the percentage of fill time devoted to certain fill stages;

FIGS. 4A-4D are side cross-sectional views of a portion of a mold cavity in various stages of fill by a conventional high variable pressure injection molding machine;

FIGS. 5A-5D are side cross-sectional views of a portion of a mold cavity in various stages of fill by the substantially constant low injection pressure molding machine of FIG. 1;

FIGS. 6-8 are schematic illustrations of preforms formed according to the methods and apparatuses described herein;

FIG. 9 is a schematic illustration of preform core-shifting for a preform formed according to the methods and apparatuses described herein;

FIG. 10 is a schematic illustration of one embodiment of an injection molding apparatus and blow molding apparatus connected by an automated transport apparatus;

FIG. 11 is a detailed schematic view of the blow molding apparatus of FIG. 10; and

FIG. 12 illustrates impact of material properties and geometry on the rate of heat transfer.

### DETAILED DESCRIPTION

The present disclosure relates to methods and apparatuses for manufacturing plastic articles, for example caps such as dosing caps, handles, packages, containers, bottles, vials, tubes, cans, toys, decorations, and the like, as well as preliminary products that may be subject to a subsequent forming process, such as parisons and preforms. The present disclosure may be used in conjunction with, for example, one step, one and a half step, and two step injection blow molding processes and apparatuses. A one step injection blow molding process may include injection molding and blow molding a preform using a single apparatus, for example, while a two step injection blow molding process may include a separate injection molding apparatus and a separate blow molding apparatus. A one and a half step injection blow molding process may include a stretching step to mechanically stretch a preform during a blow molding process, for example. The preform may therefore be formed into a final plastic article.

The present disclosure includes a first injection molding stage at an injection molding station or apparatus. A thermoplastic material is injected with an injection element into a first mold cavity or a plurality of mold cavities at a substantially constant low injection pressure to form a preliminary product, such as a preform. The preform may then be cooled, and may be subsequently reheated if necessary and blow molded at a blow molding station or apparatus. The preform is blow molded in a blow mold cavity at the blow molding station or apparatus in a secondary or subsequent forming process to form the plastic article. In some embodiments, a stretching stage may be included prior to the blow molding stage to stretch or elongate the preform using a stretch rod. The injection and blow molding stages may be carried out in the same apparatus, without removing the preform from the apparatus or allowing the preform to cool to a nominal ambient temperature (i.e. about 70° F. or about 21° C.), or the injection and blow molding stages may be carried out in separate apparatuses after the preform has cooled, for example, to a nominal ambient temperature. If carried out in separate apparatuses, the separate apparatuses may be connected by a transport apparatus, for example an automated transport apparatus such as a robotic arm, a conveyor belt, or another transport apparatus. In some embodiments, the transport apparatus may not be an automated transport apparatus.

The apparatuses and methods disclosed herein include improved injection molding and blow molding techniques comprising, in part, substantially constant and low injection pressure to form preforms. The apparatuses and methods disclosed herein may improve preform and plastic article quality by creating a more consistent and more uniform process that may reduce crystallinity and stresses contained within the preform during formation and/or cooling of the preform, which may affect the blow molding stage and formation of the final plastic article. Reduced and balanced stresses in the preform may create higher quality and more uniform final plastic articles, which may increase yields and reduce manufacturing costs.

Embodiments of the present disclosure generally relate to systems, machines, products, and methods of producing plastic articles by injection molding preforms and blow molding the preforms to form final plastic articles, and, more specifically, to systems, products, and methods of producing preforms by substantially constant low injection pressure injection molding during the injection stage, and using the preforms to create blow molded plastic articles.

The term “low pressure” as used herein with respect to melt pressure of a thermoplastic material, means melt pressures in a vicinity of a nozzle of an injection molding machine of between about 6.89 megapascals (1,000 psi) and about 103.42 megapascals (15,000 psi). However, it is contemplated that, in various embodiments of the present disclosure, the melt pressure of a thermoplastic material can be any integer value for megapascals or psi between these values, or any range formed by any of those integer values, such as, for example, ranges with a lower limit of 13.79 megapascals (2,000 psi) or 20.68 megapascals (3,000 psi), and/or ranges with an upper limit of 82.74 megapascals (12,000 psi) or 68.95 megapascals (10,000 psi) or 55.16 megapascals (8,000 psi) or 41.37 megapascals (6,000 psi), etc.

The term “substantially constant pressure” as used herein with respect to a melt pressure of a thermoplastic material, means that deviations from a reference melt pressure do not produce meaningful changes in physical properties of the thermoplastic material. For example, “substantially constant pressure” includes, but is not limited to, pressure variations for which viscosity of the melted thermoplastic material do not meaningfully change. The term “substantially constant” in this respect includes deviations of approximately +/−30% from a reference melt pressure. For example, the term “a substantially constant pressure of approximately 4,600 psi” includes pressure fluctuations within the range of about 6,000 psi (30% above 4,600 psi) to about 3,200 psi (30% below 4,600 psi). A melt pressure is considered substantially constant as long as the melt pressure fluctuates no more than +/−30% from the recited pressure. However, it is contemplated that, in various embodiments of the present disclosure, the variation of a reference melt pressure can be any integer value for percentage between −30% and +30% or any range formed by any of those integer percentage values, such as, for example, ranges with a variation lower limit of 0%, +/−5%, or +/−10%, and/or ranges with a variation upper limit of +/−25%, +/−20%, or +/−15%, with the possibility that the variations may be only positive variation, or only negative variation, or a combination of both positive and negative variation.

The term “melt holder,” as used herein, refers to the portion of an injection molding machine that contains molten plastic in fluid communication with the machine nozzle. The melt holder is heated, such that a polymer may be prepared and held at a desired temperature. The melt holder is connected to a power source, for example a hydraulic cylinder or electric servo motor, that is in communication with a central control unit or controller, and can be controlled to advance a diaphragm to force molten plastic through the machine nozzle. The molten material then flows through the runner system into the mold cavity. The melt holder may be cylindrical in cross section, or have alternative cross sections that will permit a diaphragm to force polymer under pressures that can range to 275.79 megapascals (40,000 psi) or higher through the machine nozzle. The diaphragm may optionally be integrally connected to a reciprocating screw with flights designed to plasticize polymer material prior to injection.

The term “high L/T ratio” generally refers to L/T ratios of 100 to 1,000, such as 100 to 400, 100 to 800, 200 to 1,000, 400 to 1,000, etc.

The term “peak flow rate” generally refers to the maximum volumetric flow rate, as measured at the machine nozzle.

The term “peak injection rate” generally refers to the maximum linear speed the injection ram travels in the process of forcing polymer into the feed system. The ram can be a reciprocating screw such as in the case of a single stage injection system, or a hydraulic ram such as in the case of a two stage injection system.

The term “ram rate” generally refers to the linear speed at which the injection ram travels in the process of forcing polymer into the feed system.

The term “flow rate” generally refers to the volumetric flow rate of polymer as measured at the machine nozzle. This flow rate can be calculated based on the ram rate and ram cross sectional area, or measured with a suitable sensor located in the machine nozzle.

The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity.

The term “melt temperature” generally refers to the temperature of the polymer that is maintained in the melt holder and in the material feed system when a hot runner system is used, which keeps the polymer in a molten state. The melt temperature varies by material; however, a desired melt temperature is generally understood to fall within the ranges recommended by the material manufacturer.

The term “gate size” generally refers to the cross sectional area of a gate, which is formed by the intersection of the runner and the mold cavity. For hot runner systems, the gate can be of an open design where there is no positive shut off of the flow of material at the gate, or a closed design where a valve pin is used to mechanically shut off the flow of material through the gate into the mold cavity (commonly referred to as a valve gate). The gate size refers to the cross sectional area, for example a 1 millimeter (mm) gate diameter refers to a cross sectional area of the gate that is equivalent to the cross sectional area of a gate having a 1 mm diameter at the point the gate meets the mold cavity. The cross section of the gate may be of any desired shape.

The term “effective gate area” generally refers to a cross sectional area of a gate corresponding to an intersection of the mold cavity and a material flow channel of a feed system (e.g., a runner) feeding thermoplastic material to the mold cavity. The gate could be heated or may not be heated. The gate could be round, or any cross sectional shape, suited to achieve the desired thermoplastic flow into the mold cavity.

The term “intensification ratio” generally refers to the mechanical advantage the injection power source has on the injection ram forcing the molten polymer through the machine nozzle. For hydraulic power sources, it is common that the hydraulic piston will have a 10:1 mechanical advantage over the injection ram. However, the mechanical advantage can range from ratios much lower, such as 2:1, to much higher mechanical advantage ratio such as 50:1, or anywhere inbetween.

The term “peak power” generally refers to the maximum power generated when filling a mold cavity. The peak power may occur at any point in the filling cycle. The peak power is determined by the product of the plastic pressure as measured at the machine nozzle multiplied by the flow rate as measured at the machine nozzle. Power is calculated by the formula P=p*Q where p is pressure and Q is volumetric flow rate.

The term “volumetric flow rate” generally refers to the flow rate as measured at the machine nozzle. This flow rate can be calculated based on the ram rate and ram cross sectional area, or measured with a suitable sensor located in the machine nozzle.

The terms “filled” and “full,” when used with respect to a mold cavity including thermoplastic material, are interchangeable and both terms mean that thermoplastic material has stopped flowing into the mold cavity.

The term “shot size” generally refers to the volume of polymer to be injected from the melt holder to completely fill the mold cavity or cavities. The shot size volume is determined based on the temperature and pressure of the polymer in the melt holder just prior to injection. In other words, the shot size is a total volume of molten plastic material that is injected in a stroke of an injection molding ram at a given temperature and pressure. Shot size may include injecting molten plastic material into one or more injection cavities through one or more gates. The shot of molten plastic material may also be prepared and injected by one or more melt holders.

The term “hesitation” generally refers to the point at which the velocity of the flow front is minimized sufficiently to allow a portion of the polymer to drop below its no flow temperature and begin to freeze off.

The term “electric motor” or “electric press,” when used herein includes both electric servo motors and electric linear motors.

The term “Peak Power Flow Factor” refers to a normalized measure of peak power required by an injection molding system during a single injection molding cycle and the Peak Power Flow Factor may be used to directly compare power requirements of different injection molding systems. The Peak Power Flow Factor is calculated by first determining the Peak Power, which corresponds to the maximum product of molding pressure multiplied by flow rate during the filling cycle (as defined herein), and then determining the shot size for the mold cavities to be filled. The Peak Power Flow Factor is then calculated by dividing the Peak Power by the shot size.

The term “substantially constant low injection pressure molding machine” is defined as a class 101 or a class 30 injection molding machine that uses a substantially constant injection pressure that is a low pressure. Alternatively, the term “substantially constant low injection pressure molding machine” may be defined as an injection molding machine that uses a substantially constant injection pressure that is less than or equal to a low pressure and is capable of performing about 1 million cycles to about 10 million cycles, before the mold core (which is made up of first and second mold parts that define a mold cavity therebetween) reaches the end of its useful life. In various embodiments, it is contemplated that a substantially constant low injection pressure molding machine can be configured to be capable of a number of cycles ranging from about 1 million, about 1.25 million, about 1.5 million, about 2 million, or about 2.5 million on the low end to about 5 million, about 8 million, or even about 10 million on the high end. Characteristics of “substantially constant low injection pressure molding machines” may include, for example, mold cavities having an L/T ratio of greater than 100 (as an example, greater than 200), multiple mold cavities (as another example 4 mold cavities, as another example 16 mold cavities, as another example 32 mold cavities, as another example 64 mold cavities, as another example 128 mold cavities and as another example 256 mold cavities, or any number of mold cavities between 4 and 512, a heated or cold runner, and/or a guided ejection mechanism.

The term “useful life” is defined as the expected life of a mold part before failure or scheduled replacement. When used in conjunction with a mold part or a mold core (or any part of the mold that defines the mold cavity), the term “useful life” means the time a mold part or mold core is expected to be in service before quality problems develop in the molded part, before problems develop with the integrity of the mold part (e.g., galling, deformation of parting line, deformation or excessive wear of shut-off surfaces), or before mechanical failure (e.g., fatigue failure or fatigue cracks) occurs in the mold part. Typically, the mold part has reached the end of its “useful life” when the contact surfaces that define the mold cavity must be discarded or replaced. The mold parts may require repair or refurbishment from time to time over the “useful life” of a mold part and this repair or refurbishment does not require the complete replacement of the mold part to achieve acceptable molded part quality and molding efficiency. Furthermore, it is possible for damage to occur to a mold part that is unrelated to the normal operation of the mold part, such as a part not being properly removed from the mold and the mold being forcibly closed on the non-ejected part, or an operator using the wrong tool to remove a molded part and damaging a mold component. For this reason, spare mold parts are sometimes used to replace these damaged components prior to them reaching the end of their useful life. Replacing mold parts because of damage does not change the expected useful life.

The term “guided ejection mechanism” is defined as a dynamic part that actuates to physically eject a molded part from the mold cavity.

The term “coating” is defined as a layer of material less than 0.13 mm (0.005 inch) in thickness, that is disposed on a surface of a mold part defining the mold cavity, that has a primary function other than defining a shape of the mold cavity (e.g., a function of protecting the material defining the mold cavity, or a function of reducing friction between a molded part and a mold cavity wall to enhance removal of the molded part from the mold cavity).

The term “average thermal conductivity” is defined as the thermal conductivity of any materials that make up the mold cavity or the mold side or mold part. Materials that make up coatings, stack plates, support plates, and gates or runners, whether integral with the mold cavity or separate from the mold cavity, are not included in the average thermal conductivity. Average thermal conductivity is calculated on a volume weighted basis.

The term “effective cooling surface” is defined as a surface through which heat is removed from a mold part. One example of an effective cooling surface is a surface that defines a channel for cooling fluid from an active cooling system. Another example of an effective cooling surface is an outer surface of a mold part through which heat dissipates to the atmosphere. A mold part may have more than one effective cooling surface and thus may have a unique average thermal conductivity between the mold cavity surface and each effective cooling surface.

The term “nominal wall thickness” is defined as the theoretical thickness of a mold cavity if the mold cavity were made to have a uniform thickness. The nominal wall thickness may be approximated by the average wall thickness. The nominal wall thickness may be calculated by integrating length and width of the mold cavity that is filled by an individual gate.

The term “average hardness” is defined as the Rockwell hardness for any material or combination of materials in a desired volume. When more than one material is present, the average hardness is based on a volume weighted percentage of each material. Average hardness calculations include hardnesses for materials that make up any portion of the mold cavity. Average hardness calculations do not include materials that make up coatings, stack plates, gates or runners, whether integral with a mold cavity or not, and support plates. Generally, average hardness refers to the volume weighted hardness of material in the mold cooling region.

The term “mold cooling region” is defined as a volume of material that lies between the mold cavity surface and an effective cooling surface.

The term “cycle time” is defined as a single iteration of an injection molding process that is required to fully form an injection molded part. Cycle time includes the stages of advancing molten thermoplastic material into a mold cavity, substantially filling the mold cavity with thermoplastic material, cooling the thermoplastic material, separating first and second mold sides to expose the cooled thermoplastic material, removing the thermoplastic material, and closing the first and second mold sides.

Substantially constant low injection pressure molding machines may also be high productivity injection molding machines (e.g., a class 101 or a class 30 injection molding machine, or an “ultra high productivity molding machine”), such as the high productivity injection molding machine disclosed in U.S. patent application Ser. No. 13/601,514, filed Aug. 31, 2012, which is hereby incorporated by reference herein, that may be used to produce thin-walled consumer products, such as toothbrush handles and razor handles. Thin walled parts are generally defined as having a high L/T ratio of 100 or more.

### Injection Molding Stage and Injection Molding Station

In a first stage of the method of the present disclosure, thermoplastic material is heated in a melt holder of an injection molding apparatus, or injection molding station, to a sufficient temperature, such that the thermoplastic material is in a suitable molten state, and is then injected using a plastic melt injection system or injection element into a first mold cavity of the injection molding apparatus to make a preliminary product, or a preform. A sufficient temperature for heating a thermoplastic material, can vary, depending on the type of thermoplastic material and the design of the injection molding equipment, however, in various embodiments, a sufficient temperature can be between about 90 and about 295° C., or any integer value for ° C. in that range (such as about 243° C.), or any range formed by any of those integer values, such as between about 160 and about 275° C., between about 220 and about 250° C., etc. The preform may subsequently be cooled in some embodiments and blow molded to form a final plastic article. As discussed in more detail below, preforms produced according to the methods and using the apparatuses described herein may have reduced and more balanced internal and external stresses and increased clarity, which may improve qualitative aspects of final plastic articles produced from the preforms. Preforms produced simultaneously in a plurality of mold cavities may have increased uniformity due to the substantially constant low injection pressure discussed herein.

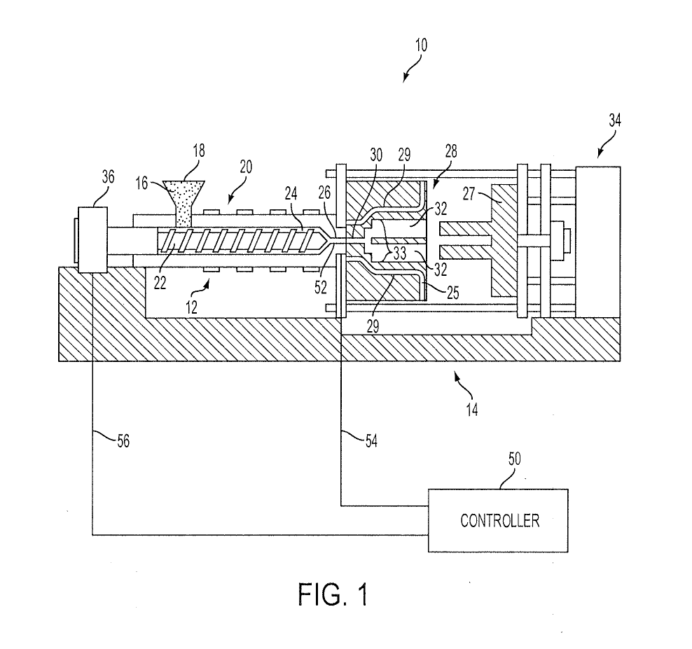

Referring now to FIG. 1, one embodiment of a substantially constant low injection pressure molding machine 10 is illustrated. The substantially constant low injection pressure molding machine 10 generally includes a plastic melt injection system 12, a clamping system 14, and a mold 28. A thermoplastic material may be introduced to the plastic melt injection system 12 in the form of thermoplastic pellets 16. The thermoplastic material may directly affect several qualities of the final plastic article, such as stresses, crystallinity, and cooling rates, as well as other qualities. Thermoplastic materials are therefore discussed thoroughly below. The thermoplastic pellets 16 may be placed into a hopper 18, which feeds the thermoplastic pellets 16 into a heated barrel 20 of the plastic melt injection system 12. The thermoplastic pellets 16, after being fed into the heated barrel 20, may be driven to the end of the heated barrel 20 by a reciprocating screw 22. The heating of the heated barrel 20 and the compression of the thermoplastic pellets 16 by the reciprocating screw 22 causes the thermoplastic pellets 16 to melt, forming a molten thermoplastic material 24. The molten thermoplastic material is typically processed at a temperature of about 130° C. to about 410° C.

The reciprocating screw 22 forces the molten thermoplastic material 24, toward a nozzle 26 to form a shot of thermoplastic material, which will be injected into a plurality of mold cavities 32 of the mold 28 via an injection element, such as one or more gates 30, preferably three or less gates, that direct the flow of the molten thermoplastic material 24 to the plurality of mold cavities 32. In other embodiments, the nozzle 26 may be separated from one or more gates 30 by a feed system (not shown).

The plurality of mold cavities 32 is formed between a first mold portion 25 and a second mold portion 27 of the mold 28. The first and second mold portions 25, 27 are formed from a material having high thermal conductivity. For example, the first and second mold portions 25, 27 may be formed from a material having a thermal conductivity of between about 30 British Thermal Units (BTUs) per (hour-foot-° F.) and about 223 BTUs per (hour-foot-° F.), or any integer value for BTU/hr-ft-° F. between these values, or any range formed by any of those integer values, such as the ranges listed below, or between about 52 Watts per meter-Kelvin and about 385 Watts per meter-Kelvin or any integer value for W/m-° K between these values, or any range formed by any of those integer values, such as the SI equivalents of the ranges listed below. In other embodiments, one or both of the first and second mold portions 25, 27 may be formed from a material having a thermal conductivity of between about 35 BTUs per (hour-foot-° F.) and about 200 BTUs per (hour-foot-° F.); or between about 40 BTUs per (hour-foot-° F.) and about 190 BTUs per (hour-foot-° F.); or between about 50 BTUs per (hour-foot-° F.) and about 180 BTUs per (hour-foot-° F.); or between about 75 BTUs per (hour-foot-° F.) and about 150 BTUs per (hour-foot-° F.).

Some illustrative materials for manufacturing all or portions of the first and/or second mold portions 25, 27 include aluminum (for example, 2024 aluminum, 2090 aluminum, 2124 aluminum, 2195 aluminum, 2219 aluminum, 2324 aluminum, 2618 aluminum, 5052 aluminum, 5059 aluminum, aircraft grade aluminum, 6,000 series aluminum, 6013 aluminum, 6056 aluminum, 6061 aluminum, 6063 aluminum, 7000 series aluminum, 7050 aluminum, 7055 aluminum, 7068 aluminum, 7075 aluminum, 7076 aluminum, 7150 aluminum, 7475 aluminum, QC-10, Alumold™, Hokotol™, Duramold 2™, Duramold 5™, and/or Alumec 99™), BeCu (for example, C17200, C 18000, C61900, C62500, C64700, C82500, Moldmax LH™, Moldmax HH™, and/or Protherm™), Copper, and any alloys of aluminum (e.g., Beryllium, Bismuth, Chromium, Copper, Gallium, Iron, Lead, Magnesium, Manganese, Silicon, Titanium, Vanadium, Zinc, and/or Zirconium), any alloys of copper (e.g., Magnesium, Zinc, Nickel, Silicon, Chromium, Aluminum, and/or Bronze). These materials may have Rockwell C (Rc) hardnesses of between about 0.5 Rc and about 20 Rc, preferably between about 2 Rc and about 20 Rc, more preferably between about 3 Rc and about 15 Rc, and more preferably between about 4Rc and about 10 Rc. The first and/or second mold portions 25, 27 may be any of these materials or any combination of these materials, or may be comprised of any of these materials. For example, the mold 28 may comprise aluminum and/or an aluminum containing core. The disclosed substantially constant low injection pressure molding methods and machines operate under molding conditions that permit molds made of softer, higher thermal conductivity materials to extract useful lives of more than 1 million cycles, for example between about 1 million cycles and about 10 million cycles, particularly between about 1.25 million cycles and about 10 million cycles, and more particularly between about 2 million cycles and about 5 million cycles.

The mold 28 may also include a cooling circuit 29, integrated into or positioned proximate to either or both the first or second mold portions 25, 27. The cooling circuit 29 may provide a path for cooling fluid to pass through one or both portions of the mold 28. The cooling fluid may remove heat from the mold 28 or a portion 25, 27 of the mold, thereby reducing the temperature of the mold 28 and in some instances, reducing the temperature of a preform contained within the mold cavity 32. As the cooling fluid passes through the mold 28, a cooling fluid temperature may be measured. For example, the cooling fluid temperature for water may be measured upon its fully regulated state (the regulated coolant temperature), as the cooling fluid exits the tap or controlled (e.g., using a thermolator or chiller). The regulated coolant temperature can vary, depending on the type of cooling fluid, the design of the cooling system, and the amount of heat being transferred from the mold, however, in various embodiments, the regulated coolant temperature can be between about 10 and about 100° C., or any integer value for ° C. in that range, or any range formed by any of those integer values, such as between about 10 and about 40° C., 15 and about 35° C., between about 20 and about 30° C., etc. The cooling fluid temperature as it reaches the mold 28 may be determined by a chiller, as discussed herein. In some embodiments, the cooling circuit 29 may have a spiral flow path, while in other embodiments, the cooling circuit 29 may have a planar, curved, or other flow path.

High thermal conductivity of the mold 28 (e.g., the first mold part 25 and/or second mold part 27) may alleviate the need for dehumidification apparatuses, as differences in temperature between the mold and the ambient environment may be reduced. Further, thermal lag in the mold may be reduced due to the high thermal conductivity of the mold. This may enable the use of, for example, evaporative cooling fluids and/or closed circuit systems.

In embodiments where the mold 28 includes the plurality of mold cavities 32, overall production rates may be increased. As discussed above, for any of the embodiments of molds described herein, any of the molds can be configured in the closed position to form between 2 mold cavities and 512 mold cavities, or any integer value for mold cavities between 2 mold cavities and 512 mold cavities, or within any range formed by any of those integer values, such as between 64 and 512, between 128 and 512, between 4 and 288 mold cavities, between 16 and 256 mold cavities, between 32 and 128 mold cavities, etc. The shapes of the cavities of each of the plurality of mold cavities may be identical, similar, or different from each other. The mold cavities may also be formed from more than two mold portions. In embodiments where the shapes of the plurality of mold cavities are different from each other, the plurality of mold cavities may be considered a family of mold cavities.

The first and second mold portions 25, 27 are held together under pressure by a press or clamping unit 34. The press or clamping unit 34 applies a clamping force during the molding process that is greater than the force exerted by the injection pressure acting to separate the first and second mold portions 25, 27, thereby holding the first and second mold portions 25, 27 together while the molten thermoplastic material 24 is injected into the plurality of mold cavities 32. To support these clamping forces, the clamping system 14 may include a mold frame and a mold base. As discussed below, the molten thermoplastic material 24 is injected into the plurality of mold cavities 32 at a melt pressure that is low pressure and substantially constant pressure.

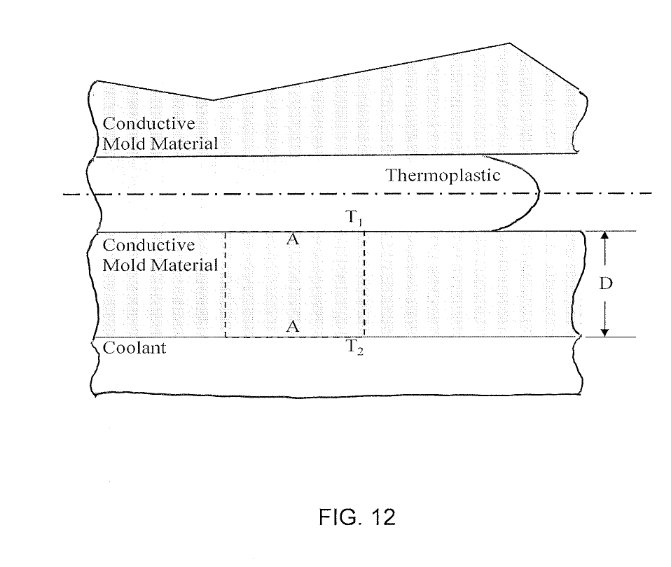

Molten thermoplastic material 24 is advanced into the plurality of mold cavities 32 until the plurality of mold cavities 32 is substantially filled. The molten thermoplastic material 24 may be advanced at a melt temperature measured as the thermoplastic material 24 leaves the injection element and enters at least one of the plurality of mold cavities 32. The melt temperature may be, for example, between about 90° C. and about 300° C., such as about 243° C. FIG. 12 illustrates impact of material properties and geometry on the rate of heat transfer. The plurality of mold cavities 32 may be substantially filled when the plurality of mold cavities 32 is more than about 90% filled, particularly more than about 95% filled and more particularly more than about 99% filled. Once the shot of molten thermoplastic material 24 is injected into the plurality of mold cavities 32, the reciprocating screw 22 stops traveling forward.

A controller 50 is communicatively connected with a sensor 52, which may be located in the vicinity of the nozzle 26, the injection element or gates 30, and a screw control 36. The controller 50 may include a microprocessor, a memory, and one or more communication links. When melt pressure and/or melt temperature of the thermoplastic material is measured by the sensor 52, this sensor 52 may send a signal indicative of the pressure or the temperature to the controller 50 to provide a target pressure for the controller 50 to maintain in the plurality of mold cavities 32 (or in the nozzle 26) as the fill is completed. This signal may generally be used to control the molding process, such that variations in material viscosity, mold temperatures, melt temperatures, and other variations influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensor 52 and the screw control 36 via wired connections 54, 56, respectively. In other embodiments, the controller 50 may be connected to the sensor 52 and screw control 36 via a wireless connection, a mechanical connection, a hydraulic connection, a pneumatic connection, or any other type of communication connection known to those having ordinary skill in the art that will allow the controller 50 to communicate with both the sensor 52 and the screw control 36 (e.g., a feedback loop).

In the embodiment of FIG. 1, the sensor 52 is a pressure sensor that measures (directly or indirectly) melt pressure of the molten thermoplastic material 24 in the vicinity of the nozzle 26. The sensor 52 generates an electrical signal that is transmitted to the controller 50. The controller 50 then commands the screw control 36 to advance the screw 22 at a rate that maintains a desired melt pressure of the molten thermoplastic material 24 in the nozzle 26. While the sensor 52 may directly measure the melt pressure, the sensor 52 may also indirectly measure the melt pressure by measuring other characteristics of the molten thermoplastic material 24, such as temperature, viscosity, flow rate, etc., which are indicative of melt pressure. Likewise, the sensor 52 need not be located directly in the nozzle 26, but rather the sensor 52 may be located at any location within the plastic melt injection system 12 or mold 28 that is fluidly connected with the nozzle 26. If the sensor 52 is not located within the nozzle 26, appropriate correction factors may be applied to the measured characteristic to calculate an estimate of the melt pressure in the nozzle 26. The sensor 52 need not be in direct contact with the injected material and may alternatively be in dynamic communication with the material and able to sense the pressure of the material and/or other fluid characteristics. If the sensor 52 is not located within the nozzle 26, appropriate correction factors may be applied to the measured characteristic to calculate the melt pressure in the nozzle 26. In yet other embodiments, the sensor 52 need not be disposed at a location that is fluidly connected with the nozzle 26. Rather, the sensor 52 could measure clamping force generated by the clamping system 14 at a mold parting line between the first and second mold portions 25, 27. In one aspect, the controller 50 may maintain the pressure according to the input from sensor 52. Alternatively, the sensor 52 could measure an electrical power demand by an electric press, which may be used to calculate an estimate of the pressure in the nozzle 26.

Although an active, closed loop controller 50 is illustrated in FIG. 1, other pressure regulating devices may be used instead of the closed loop controller 50. For example, a pressure regulating valve (not shown) or a pressure relief valve (not shown) may replace the controller 50 to regulate the melt pressure of the molten thermoplastic material 24. More specifically, the pressure regulating valve and pressure relief valve can prevent overpressurization of the mold 28. Another alternative mechanism for preventing overpressurization of the mold 28 is an alarm that is activated when an overpressurization condition is detected.

The substantially constant low injection pressure molding machine 10 may further use another sensor (such as the sensor 52 in FIG. 1 above) located near an end of flow position (i.e., near an end of the mold cavity) to monitor changes in material viscosity, changes in material temperature, and changes in other material properties. Measurements from this sensor may be communicated to the controller 50 to allow the controller 50 to correct the process in real time to ensure the melt front pressure is relieved prior to the melt front reaching the end of the plurality of mold cavities 32, which can cause flashing of the mold 28, and another pressure and power peak. Moreover, the controller 50 may use the sensor measurements to adjust the peak power and peak flow rate points in the process, so as to achieve consistent processing conditions. In addition to using the sensor measurements to fine tune the process in real time during the current injection cycle, the controller 50 may also adjust the process over time (e.g., over a plurality of injection cycles). In this way, the current injection cycle can be corrected based on measurements occurring during one or more cycles at an earlier point in time. In one embodiment, sensor readings can be averaged over many cycles so as to achieve process consistency.

Upon injection into the plurality of mold cavities 32, the molten thermoplastic material 24 contacts a mold preform contact surface 33 within each mold cavity 32 and takes the form of the plurality of mold cavities 32 and the molten thermoplastic material 24 cools inside the mold 28 until the thermoplastic material 24 solidifies or is substantially frozen. The molten thermoplastic material 24 may be actively cooled with an active cooling apparatus that includes a cooling liquid flowing through at least one of the first and second mold portions 25, 27, or passively cooled through convection and conduction to the atmosphere, as discussed below. Once the thermoplastic material 24 has solidified, the press 34 releases the first and second mold portions 25, 27. At which point, the first and second mold portions 25, 27 are separated from one another, and the finished part, in this embodiment a preform, may be ejected from the mold 28. The preform may be ejected or removed by, for example, ejection, dumping, releasing, removing, extraction (manually or via an automated process, including robotic action), pulling, pushing, gravity, or any other method of separating the cooled preform from the first and second mold portions 25, 27. After the cooled preform is removed from the first and second mold portions 25, 27, the first and second mold portions 25, 27 may be closed, reforming the plurality of mold cavities 32. The reforming of the plurality of mold cavities 32 prepares the first and second mold portions 25, 27 to receive a new shot of molten thermoplastic material, thereby completing a single mold cycle. Cycle time is defined as a single iteration of the molding cycle. A single molding cycle for a one step injection blow molding cycle may take between about 2 seconds and about 15 seconds, preferably between about 8 seconds and about 10 seconds, depending on the part size and material. A single molding cycle for a one and a half or a two step injection blow molding cycle may take between, for example, about 8 seconds and about 60 seconds, depending on the part size and material.

During the injection molding process, heat from the molten thermoplastic material 24 may be transferred to the mold 28, thereby increasing the mold temperature. The mold temperature may be measured at different positions within the mold 28, such as two millimeters below the mold preform contact surface 33 (e.g., between about 50° F. and about 70° F., such as about 66° F.), such that the mold temperature is calculated or measured at an internal position of the mold 28. The mold temperature may also be measured at the mold preform contact surface 33 (e.g., between about 50° F. and about 70° F.), or at another position. Without wishing to be bound by theory, it is believed that a relatively low temperature difference between the mold temperature (or regulated cooling fluid temperature) and melt temperature of the thermoplastic material can result in the reduced and balanced internal and external stresses within the preforms. A relatively low temperature difference between the internal mold cavity temperature measured two millimeters away from a mold cavity preform contact surface and a regulated coolant temperature of the cooling fluid may also be indicative of the reduced and balanced internal and external stresses within the preforms. For example, a difference between the melt temperature of the thermoplastic material as the thermoplastic material leaves the injection element and a regulated coolant temperature of the cooling fluid may be less than or equal to about 285° C., such as less than or equal to about 233° C. As another example, a difference between the melt temperature of the thermoplastic material as the thermoplastic material leaves the injection element and a internal mold cavity temperature at a mold cavity preform contact surface may be less than or equal to about 285° C., such as less than or equal to about 233° C. As another example, a difference between an internal mold cavity temperature, measured two millimeters away from a mold cavity preform contact surface, and a regulated coolant temperature of the cooling fluid is less than or equal to about 70° C., such as about 66° C. or less.

In various embodiments, the mold 28 may include the cooling system or cooling circuit 29. The cooling system or cooling circuit may assist in maintaining a portion of, or the entire, mold 28 and/or plurality of mold cavities 32 at a temperature below the no-flow temperature of the thermoplastic material 24. For example, even surfaces of the plurality of mold cavities 32 which contact the shot comprising molten thermoplastic material 24 can be cooled to maintain a lower temperature. Any suitable cooling temperature can be used, such as about 10° C. For example, the mold 28 can be maintained substantially at a nominal ambient temperature. Incorporation of such cooling systems can advantageously enhance the rate at which the as-formed injection molded part is cooled and ready for ejection from the mold. Additionally, because of the high thermal conductivity of the molds described herein, the mold may not retain all or most of the heat, as heat transferred to the mold may be subsequently transferred to the cooling fluid over a short period of time. For example, the mold 28 may have or maintain a temperature of greater than or equal to about 90° C. during the injection stage of the molten thermoplastic material, which may avoid condensation on or around the mold 28, thereby eliminating the need for dehumidification apparatuses.

Cooling circuits may allow for heat to be removed from the plurality of mold cavities 32, and for the temperature of the preform formed within the plurality of mold cavities 32 to be reduced. The cooling circuit may be, for example, a spiral cooling circuit positioned in both the first and second mold portions 25, 27. In other embodiments, the cooling circuit may comprise straight tubing. The cooling circuit may be configured to direct a cooling fluid, such as water, to and away from the first and second mold portions 25, 27 such that heat is removed from the plurality of mold cavities 32 (and thus the thermoplastic material and/or the preform) and transferred to the cooling fluid. The cooling fluid may be fluidically coupled to a chiller system (not shown) to remove heat retained in the cooling fluid. Due to the thermal conductivity of the mold 28, the heat transferred to the cooling fluid from the mold 28 should be fairly uniform and efficient, in that the temperature throughout the mold 28 should remain substantially similar. Heat removed from the mold 28 may further remove heat from the preform, resulting in substantially balanced cooling and more efficient cooling for the preform, which may reduce stresses molded into the preform, and may also substantially balance, or otherwise make more uniform, stresses molded into the preform.

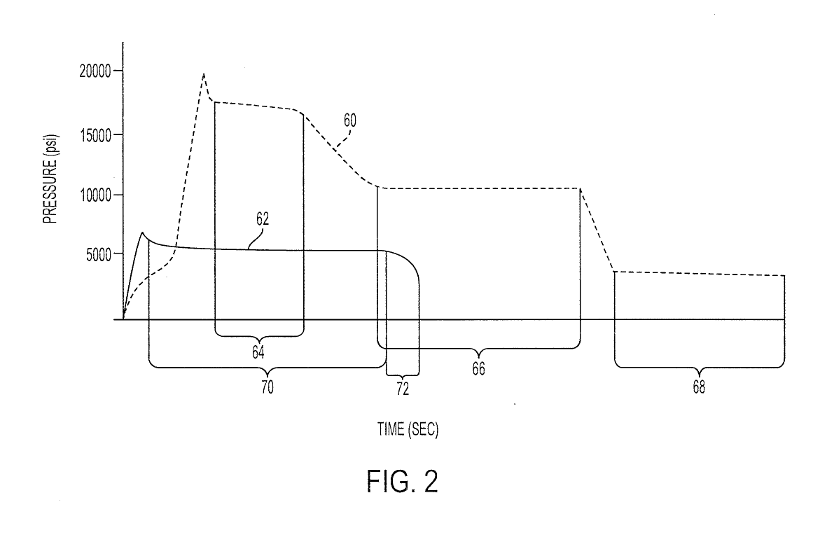

Referring now to FIG. 2, a typical pressure-time curve for a conventional high variable pressure injection molding process is illustrated by the dashed line 60. By contrast, a pressure-time curve for the disclosed substantially constant low injection pressure molding machine is illustrated by the solid line 62.

In the conventional case, melt pressure is rapidly increased to well over about 15,000 psi and then held at a relatively high pressure, more than about 15,000 psi, for a first period of time 64. The first period of time 64 is the fill time in which molten plastic material flows into the mold cavity. Thereafter, the melt pressure is decreased and held at a lower, but still relatively high pressure, for a second period of time 66. The second period of time 66 is a packing time in which the melt pressure is maintained to ensure that all gaps in the mold cavity are back filled. After packing is complete, the pressure may optionally be dropped again for a third period of time 68, which is the cooling time. The mold cavity in a conventional high variable pressure injection molding system is packed from the end of the flow channel back to towards the gate. The material in the mold typically freezes off near the end of the cavity, then the completely frozen off region of material progressively moves toward the gate location, or locations. As a result, the plastic near the end of the mold cavity is packed for a shorter time period and with reduced pressure, than the plastic material that is closer to the gate location, or locations. Part geometry, such as very thin cross sectional areas midway between the gate and end of mold cavity, can also influence the level of packing pressure in regions of the mold cavity. Inconsistent packing pressure may cause inconsistencies in the finished product, including uneven wall thickness, unbalanced stresses, and high levels of crystallinity. Moreover, the conventional packing of plastic in various stages of solidification results in some non-ideal material properties, for example, molded-in stresses, sink, and non-optimal optical properties.

The substantially constant low injection pressure molding machine 10, on the other hand, injects the molten plastic material into the mold cavity at a substantially constant pressure for a fill time period 70. The injection pressure in the example of FIG. 2 is less than 6,000 psi. Other embodiments may use lower pressures. After the mold cavity is filled, the substantially constant low injection pressure molding machine 10 gradually reduces pressure over a second time period 72 as the molded part is cooled. By using a substantially constant pressure, the molten thermoplastic material maintains a continuous melt flow front that advances through the flow channel from the gate towards the end of the flow channel. In other words, the molten thermoplastic material remains moving throughout the mold cavity, which prevents premature freeze off. Thus, the plastic material remains relatively uniform at any point along the flow channel, which results in a more uniform and consistent finished product. By filling the mold with a relatively uniform pressure, the finished molded parts form crystalline structures that may have better mechanical and optical properties than conventionally molded parts. Moreover, the parts molded at constant pressures exhibit different characteristics than skin layers of conventionally molded parts. As a result, parts molded under constant pressure may have better optical properties than parts of conventionally molded parts.

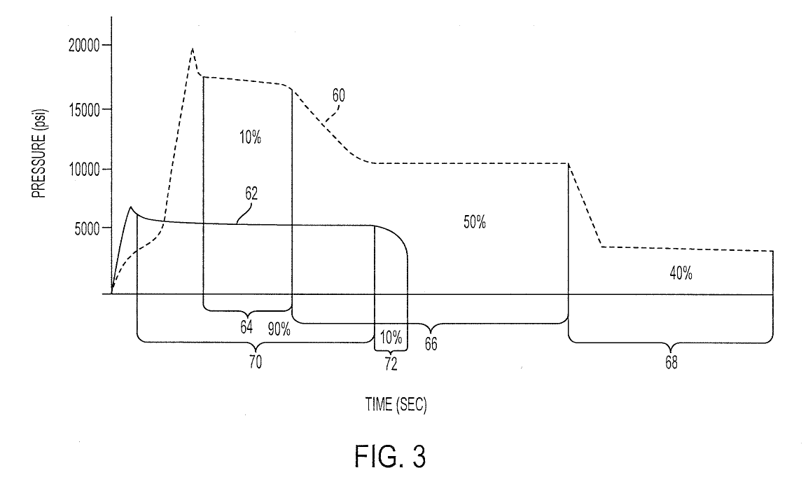

Turning now to FIG. 3, the various stages of fill are broken down as percentages of overall fill time. For example, in a conventional high variable pressure injection molding process, the fill period 64 makes up about 10% of the total fill time, the packing period 66 makes up about 50% of the total fill time, and the cooing period 68 makes up about 40% of the total fill time. On the other hand, in the substantially constant pressure injection molding process described herein, the fill period 70 makes up about 90% of the total fill time while the cooling period 72 makes up only about 10% of the total fill time. The substantially constant pressure injection molding process needs less cooling time because the molten plastic material is cooling as it is flowing into the mold cavity. Thus, by the time the mold cavity is filled, the molten plastic material has cooled significantly, although not quite enough to freeze off in the center cross section of the mold cavity, and there is less total heat to remove to complete the freezing process. Additionally, because the molten plastic material remains liquid throughout the fill, and packing pressure is transferred through this molten center cross section, the molten plastic material remains in contact with the mold cavity walls (as opposed to freezing off and shrinking away). As a result, the substantially constant pressure injection molding process described herein is capable of filling and cooling a molded part in less total time than in a conventional high variable pressure injection molding process.

Peak power and peak flow rate vs. percentage of mold cavity fill are illustrated in FIG. 3 for both conventional high variable pressure processes 60 and for substantially constant pressure processes 62. In the substantially constant pressure process 62, the peak power load occurs at a time approximately equal to the time the peak flow rate occurs, and then declines steadily through the filling cycle. More specifically, the peak power and the peak flow rate occur in the first 30% of fill, and, in another example, in the first 20% of fill, and, in yet another example, in the first 10% of fill. By arranging the peak power and peak flow rate to occur during the beginning of fill, the thermoplastic material is not subject to the extreme conditions when it is closer to freezing. It is believed that this results in superior physical properties of the molded parts.

The power level generally declines slowly through the filling cycle following the peak power load. Additionally, the flow rate generally declines slowly through the filling cycle following the peak flow rate because the fill pressure is maintained substantially constant. As illustrated above, the peak power level is lower than the peak power level for a conventional process, generally from about 30 to about 50% lower and the peak flow rate is lower than the peak flow rate for a conventional process, generally from about 30 to about 50% lower.

Similarly, the peak power load for a conventional high variable pressure process occurs at a time approximately equal to the time the peak flow rate occurs. However, unlike the substantially constant process, the peak power and flow rate for the conventional high variable pressure process occur in the final 10%-30% of fill, which subjects the thermoplastic material to extreme conditions as it is in the process of freezing. Also unlike the substantially constant pressure process, the power level in the conventional high variable pressure process generally declines rapidly through the filling cycle following the peak power load. Similarly, the flow rate in a conventional high variable pressure process generally declines rapidly through the filling cycle following the peak flow rate.

Alternatively, in one or more embodiments shown and described herein, the peak power may be adjusted to maintain a substantially constant injection pressure. More specifically, the filling pressure profile may be adjusted to cause the peak power to occur in the first 30% of the cavity fill, in another example, in the first 20% of the cavity fill, and, in yet another example, in the first 10% of the cavity fill. Adjusting the process to cause the peak power to occur within the specific ranges, and then to have a decreasing power throughout the remainder of the cavity fill results in the same benefits for the molded part that were described above with respect to adjusting peak flow rate. Moreover, in one or more embodiments of the substantially constant pressure injection molding method and/or machine, adjusting the process in the manner described may be used for thin wall parts (e.g., L/T ratio>100) and for large shot sizes (e.g., more than 50 cc, in particular more than 100 cc).

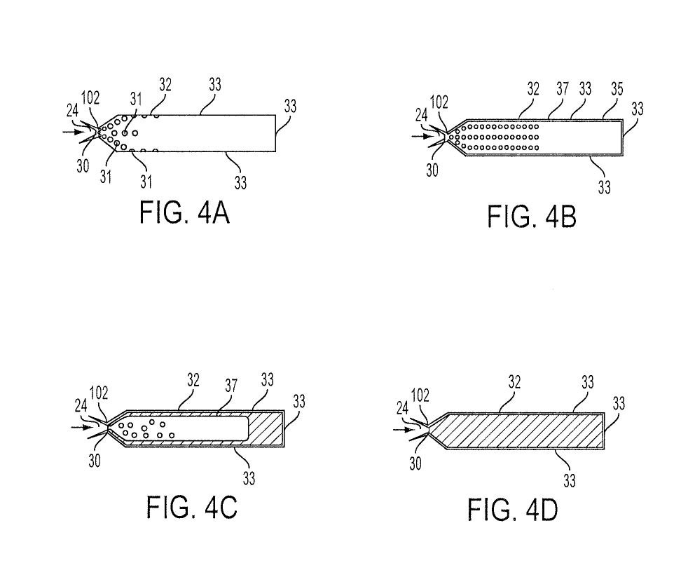

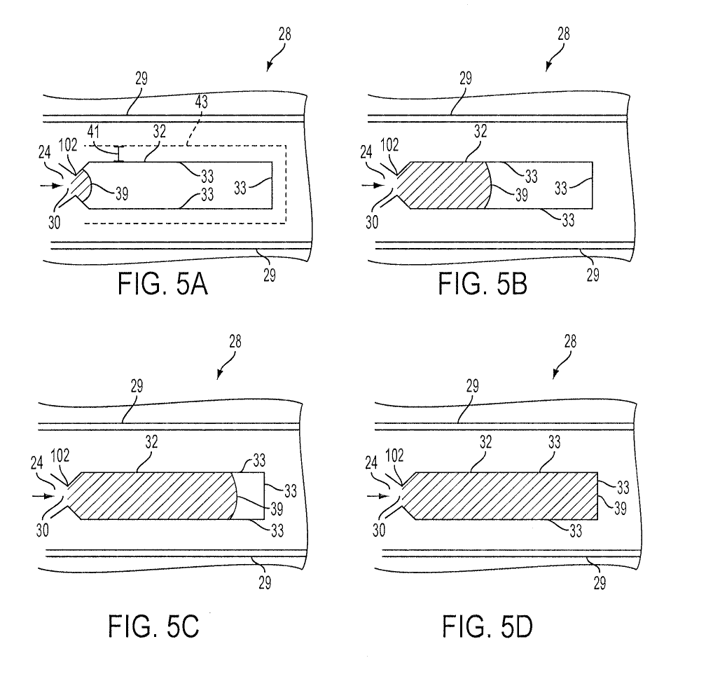

Turning now to FIGS. 4A-4D and FIGS. 5A-5D a portion of a mold cavity as it is being filled by a conventional high variable pressure injection molding machine (FIGS. 4A-4D) and as it is being filled by a substantially constant pressure injection molding machine (FIGS. 5A-5D) of the disclosure herein is illustrated.

As illustrated in FIGS. 4A-4D, as the conventional high variable pressure injection molding machine begins to inject molten thermoplastic material 24 into a plurality of mold cavities 32 through the gate 30, the high injection pressure tends to inject the molten thermoplastic material 24 into the plurality of mold cavities 32 at a high rate of speed, which causes the molten thermoplastic material 24 to flow in laminates 31, most commonly referred to as laminar flow (FIG. 4A). These outermost laminates 31 adhere to mold preform contact surfaces 33 of the mold cavity and subsequently cool and freeze, forming a frozen boundary layer 37 (FIG. 4B), before the plurality of mold cavities 32 is completely full. As the thermoplastic material freezes, however, it also shrinks away from the wall of the plurality of mold cavities 32, leaving a gap 35 between the mold cavity wall and the boundary layer 37. This gap 35 reduces cooling efficiency of the mold. Molten thermoplastic material 24 also begins to cool and freeze in the vicinity of the gate 30, which reduces the effective cross-sectional area of the gate 30. In order to maintain a constant volumetric flow rate, the conventional high variable pressure injection molding machine must increase pressure to force molten thermoplastic material through the narrowing gate 30. As the thermoplastic material 24 continues to flow into the plurality of mold cavities 32, the boundary layer 37 grows thicker (FIG. 4C). Eventually, the entire plurality of mold cavities 32 is substantially filled by thermoplastic material that is frozen (FIG. 4D). At this point, the conventional high pressure injection molding machine must maintain a packing pressure to push the receded boundary layer 37 back against the plurality of mold cavities 32 walls to increase cooling.

Referring now to FIGS. 5A-5D, the substantially constant low injection pressure molding machine 10, on the other hand, flows molten thermoplastic material into a plurality of mold cavities 32 with a constantly moving flow front 39. The thermoplastic material 24 behind the flow front 39 remains molten until the mold cavity 32 is substantially filled (i.e., about 99% or more filled) before freezing. As a result, there is no reduction in effective cross-sectional area of the gate 30, and a constant injection pressure is maintained. Moreover, because the thermoplastic material 24 is molten behind the flow front 39, the thermoplastic material 24 remains in contact with the walls of the plurality of mold cavities 32. As a result, the thermoplastic material 24 is cooling (without freezing) during the fill portion of the molding process. Thus, the cooling portion of the injection molding process need not be as long as a conventional process.

Because the thermoplastic material remains molten and keeps moving into the plurality of mold cavities 32, less injection pressure is required than in conventional molds. In one embodiment, the injection pressure may be about 6,000 psi or less. As a result, the injection systems and clamping systems need not be as powerful. For example, the disclosed substantially constant injection pressure devices may use clamps requiring lower clamping forces, and a corresponding lower clamping power source. Moreover, the disclosed injection molding machines, because of the lower power requirements, may employ electric presses, which are generally not powerful enough to use in conventional high variable pressure injection molding method and/or machine (e.g., class 101 and 102 injection molding machines). Even when electric presses are sufficient to use for some simple, molds with few mold cavities, the process may be improved with the disclosed substantially constant injection pressure methods and devices as smaller, less expensive electric motors may be used. The disclosed constant pressure injection molding machines may comprise one or more of the following types of electric presses, a direct servo drive motor press, a dual motor belt driven press, a dual motor planetary gear press, and a dual motor ball drive press having a power rating of 200 HP or less.

When filling at a substantially constant pressure, it was conventionally thought that the filling rates would need to be reduced relative to conventional filling methods. This means the polymer would be in contact with the cool molding surfaces for longer periods before the mold would completely fill. Thus, more heat would need to be removed before filling, and this would be expected to result in the material freezing off before the mold is filled. However, to the contrary, when using the substantially constant injection pressure molding machines and methods shown and described herein, the thermoplastic material will flow when subjected to substantially constant pressure conditions despite a portion of the mold cavity being below the no-flow temperature of the thermoplastic material. It would be generally expected by one of ordinary skill in the art that such conditions would cause the thermoplastic material to freeze and plug the mold cavity rather than continue to flow and fill the entire mold cavity. Without intending to be bound by theory, it is believed that the substantially constant pressure conditions of embodiments of the disclosed method and device allow for dynamic flow conditions (i.e., constantly moving melt front) throughout the entire mold cavity during filling. There is no hesitation in the flow of the molten thermoplastic material as it flows to fill the mold cavity and, thus, no opportunity for freeze-off of the flow despite at least a portion of the mold cavity being below the no-flow temperature of the thermoplastic material.

Additionally, it is believed that as a result of the dynamic flow conditions, the molten thermoplastic material is able to maintain a temperature higher than the no-flow temperature, despite being subjected to such temperatures in the mold cavity, as a result of shear heating. It is further believed that the dynamic flow conditions interfere with the formation of crystal structures in the thermoplastic material as it begins the freezing process. Crystal structure formation increases the viscosity of the thermoplastic material, which can prevent suitable flow to fill the cavity. The reduction in crystal structure formation and/or crystal structure size can allow for a decrease in the thermoplastic material viscosity as it flows into the cavity and is subjected to the low temperature of the mold that is below the no-flow temperature of the material.

Once the material is injected, the preform and, optionally the cavity, may be cooled. The preform and the cavity may be allowed to cool passively or actively. Passive cooling could involve simply leaving the preform to cool naturally within the mold. Active cooling may involve using a further device to assist and accelerate cooling. Active cooling may be achieved by passing a coolant, typically water, close to the mold, or blowing cool air, as another coolant example, at the cavity and/or product. The coolant absorbs the heat from the mold and keeps the mold at a suitable temperature to solidify the material at the most efficient rate. The mold (e.g., mold 28) can be opened when the part has solidified sufficiently to retain its shape, enabling the material to be demolded from the mold cavity without damage. However, the preform may not be ejected from the molding unit. If the preform has a collar, the collar of the preform may be actively cooled to reduce deformation. More preferably the preform is cooled using coolant which passed close to, but separate from the molding unit. Cooling can take from 1-15 seconds, preferably 2-10 seconds, most preferably 3-8 seconds. Actively cooling is beneficial to decreasing cycle times of the manufacturing process. In FIG. 5A, for example, cooling circuit 29 is illustrated. Cooling fluid temperature may be measured as it flows near the mold cavity 32, and mold temperature may be measured or calculated at a measuring point 42 that is a distance 41 away from the mold preform contact surface 33. In some embodiments, the distance 41 may be two millimeters, while in other embodiments the distance 41 may be 2 centimeters, for example.

The preform is preferably allowed to cool to a point below the glass transition temperature of the material. At temperatures below the glass transition temperature, the preform rapidly solidifies, retaining its shape. For example, polypropylene is cooled to a temperature of about 50° C. to about 100° C., particularly from about 50 to about 60° C. In a particularly preferred embodiment, the collar of the preform is permitted to cool, preferably below about 50 to about 60° C. so that it retains its molded shape. The remaining area, which will be blown during a blow molding stage discussed below, may be kept at a higher temperature. Fast cooling of the cavity and/or preform can add gloss or shine to portions of the outer surface thereof.

Further stages may be incorporated into the injection molding method of the present disclosure. In one embodiment, multiple injection stages or co-injection stages may be included. In this embodiment, a first material may be injected into the mold cavity to produce a first portion of the preform. The first portion of the preform may then be cooled to a temperature low enough to allow further mold operations without damaging or unintentionally modifying the first portion of the preform. After the first portion of the preform is cooled and sufficiently solid, the mold cavity shape is changed. A second material can then be co-injected into the new cavity shape to make a second portion of the preform. The second material may be chemically distinct from the first material. The preform is made in such a way that the materials from the first and second injections are in direct contact with one another, allowing the materials to bond. Hence, the temperature of both portions of the preform is preferably sufficient to achieve bonding. The second material to be injected can be the same material as the first material, or different. Alternatively two materials may be co-injected simultaneously into the first cavity during a co-injection technique.

Equipment to achieve multiple injection stages is known as a core-back technology. Once the first material has been injected into the cavity and is sufficiently cooled, a core unit, or core-back, is removed creating an open space in the cavity which was previously not accessible to the first material at the time of the injection. Since the first material has now been formed and cooled, it cannot flow to occupy the newly made space. A second injection can then take place, preferably at a different injection location within the newly open cavity space, to inject a second material, adding an additional feature to the preform. The injection stages of either or both of the first and second materials may incorporate the substantially constant low injection pressures described herein, which may provide the same benefits obtained in single material injection preforms.

If both the first and the second materials are the same or chemically similar, thermal bonding between them is improved. It is also possible to inject different thermoplastic material, and although bonding between them is more difficult, it allows the product to have multiple characteristics, such as different transparency, opacity or flexibility.

Creating the preform from two materials permits the manufacturer to treat the materials and the injected products thereof differently. For example, where the first material is used to make the collar of the preform, it may be cooled more quickly that the second material. The temperature of the second portion of the preform can then be maintained at a higher temperature to improve efficiency during the blow molding stage, potentially avoiding or reducing the need to reheat or prolong cooling. In this way, a preform may be built comprising further features, or use different colored materials, materials with different translucency, or different materials to perform different functions or provide different aesthetics.

In embodiments where the injection molding stage is electric driven, rather than hydraulic driven, the machinery footprint may be reduced. With a reduced footprint, faster and/or lighter spin/cube molds may be used.

Thermoplastic Materials

The preform and plastic articles discussed herein are made using a thermoplastic material. Any suitable thermoplastic material may be useful herein. Such thermoplastic materials may include normally solid polymers and resins. In general, any solid polymer of an aliphatic mono-1-olefin can be used within the scope of this disclosure. Examples of such materials include polymers and copolymers of aliphatic mono-1-olefins, such as ethylene, propylene, butene-1, hexene-1, octene-1, and the like, and blends of these polymers and copolymers. Polymers of aliphatic mono-1-olefins having a maximum of 8 carbon atoms per molecule and no branching nearer the double bond than the fourth position provide products having particularly desirable properties. Other thermoplastic materials that can be used in the practice of the disclosure include the acrylonitrile-butadiene-styrene resins, cellulosics, copolymers of ethylene and a vinyl monomer with an acid group such as methacrylic acid, phenoxy polymers, polyamides, including polyamide-imide (PAI), polycarbonates, vinyl copolymers and homopolymer, polymethylmethacrylate, polycarbonate, diethyleneglycol bisarylcarbonate, polyethylene naphthalate, polyvinyl chloride, polyurethane, epoxy resin, polyamide-based resins, low-density polyethylene, high-density polyethylene, low-density polypropylene, high-density polypropylene, polyethylene terephthalate, styrene butadiene copolymers, acrylonitrile, acrylonitrile-butadiene copolymer, cellulose acetate butyrate and mixtures thereof, polyaryletherketone (PAEK or Ketone), polybutadiene (PBD), polybutylene (PB, Polybutylene terephthalate (PBT), Polyetheretherketone (PEEK), Polyetherimide (PEI), Polyethersulfone (PES), Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polystyrene (PS), Polysulfone (PSU), Polyvinyl chloride (PVC), Polyvinylidene chloride (PVDC), and Spectralon. Further preferred materials include Ionomers, Kydex, a trademarked acrylic/PVC alloy, Liquid Crystal Polymer (LCP), Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polyethylene furanoate (PEF), Polyethylene terephthalate glycol-modified (PETG), Poly(cyclohexanedimethylene terephthalate) (PCT), Poly(cyclohexanedimethylene terephthalate) glycol modified (PCTG), Poly(cyclohexylene dimethylene terephthalate) acid (PCTA), and Polytrimethylene terephthalate (PTT), and mixtures thereof.

Other thermoplastic materials that can be used in the practice of the disclosure include the group of thermoplastic elastomers, known as TPE, which include styrenic block copolymers, polyolefin blends, elastomeric alloys (TPE-v and TPV), thermoplastic polyurethanes (TPU), thermoplastic copolyester and thermoplastic polyamides.

Additional illustrative thermoplastic materials are those selected from the group consisting of polyolefins and derivatives thereof. In other examples, the thermoplastic material is selected from the group consisting of polyethylene, polypropylene, including low-density, but particularly high-density polyethylene and polypropylene. Polyesters such as polyethylene terephthalate, polyethylene furanoate (PEF), thermoplastic elastomers from polyolefin blends, copolymers of polyethlyene and mixtures thereof.

Further illustrated polyolefins include, but are not limited to, polymethylpentene and polybutene-1. Any of the aforementioned polyolefins could be sourced from bio-based feedstocks, such as sugarcane or other agricultural products, to produce a bio-polypropylene or bio-polyethylene. Polyolefins may demonstrate shear thinning when in a molten state. Shear thinning is a reduction in viscosity when the fluid is placed under compressive stress. Shear thinning can beneficially allow for the flow of the thermoplastic material to be maintained throughout the injection molding process. Without intending to be bound by theory, it is believed that the shear thinning properties of a thermoplastic material, and in particular polyolefins, results in less variation of the materials viscosity when the material is processed at constant pressures. As a result, one or more embodiments of the substantially constant injection pressure molding machines and methods of the present disclosure can be less sensitive to variations in the thermoplastic material, for example, resulting from colorants and other additives as well as processing conditions. This decreased sensitivity to batch-to-batch variations of the properties thermoplastic material can also advantageously allow post-industrial and post consumer recycled plastics to be processed using embodiments of the apparatuses and methods of the present disclosure. Post-industrial, post consumer recycled plastics are derived from end products that have completed their life cycle as a consumer item and would otherwise have been disposed of as a solid waste product. Such recycled plastic, and blends of thermoplastic materials, inherently have significant batch-to-batch variation of their material properties.

The preforms and plastic articles using one or more embodiments of the substantially constant injection pressure molding machines and methods of the present disclosure may be formed from a virgin resin, a reground or recycled resin, petroleum derived resins, bio-derived resins from plant materials, and combinations of such resins. The containers may comprise fillers and additives in addition to the base resin material. Exemplary fillers and additives include colorants, cross-linking polymers, inorganic and organic fillers such as calcium carbonate, opacifiers, and processing aids as these elements are known in the art.

The thermoplastic material can also be, for example, a polyester. Illustrative polyesters include, but are not limited to, polyethylene terphthalate (PET). The PET polymer could be sourced from bio-based feedstocks, such as sugarcane or other agricultural products, to produce a partially or fully bio-PET polymer. Other suitable thermoplastic materials include copolymers of polypropylene and polyethylene, and polymers and copolymers of thermoplastic elastomers, polyester, polystyrene, polycarbonate, poly(acrylonitrile-butadiene-styrene), poly(lactic acid), bio-based polyesters such as poly(ethylene furanate) polyhydroxyalkanoate, poly(ethylene furanoate), (considered to be an alternative to, or drop-in replacement for, PET), polyhydroxyalkanoate, polyamides, polyacetals, ethylene-alpha olefin rubbers, and styrene-butadiene-styrene block copolymers. The thermoplastic material can also be a blend of multiple polymeric and non-polymeric materials. The thermoplastic material can be, for example, a blend of high, medium, and low molecular polymers yielding a multi-modal or bi-modal blend. The multi-modal material can be designed in a way that results in a thermoplastic material that has superior flow properties yet has satisfactory chemo/physical properties. The thermoplastic material can also be a blend of a polymer with one or more small molecule additives. The small molecule could be, for example, a siloxane or other lubricating molecule that, when added to the thermoplastic material, improves the flowability of the polymeric material.

Other additives may include inorganic fillers such calcium carbonate, calcium sulfate, talcs, clays (e.g., nanoclays), aluminum hydroxide, CaSiO3, glass formed into fibers or microspheres, crystalline silicas (e.g., quartz, novacite, crystallobite), magnesium hydroxide, mica, sodium sulfate, lithopone, magnesium carbonate, iron oxide; or, organic fillers such as rice husks, straw, hemp fiber, wood flour, or wood, bamboo or sugarcane fiber.

Other suitable thermoplastic materials include renewable polymers such as nonlimiting examples of polymers produced directly from organisms, such as polyhydroxyalkanoates (e.g., poly(beta-hydroxyalkanoate), poly(3-hydroxybutyrate-co-3-hydroxyvalerate, NODAX (Registered Trademark)), and bacterial cellulose; polymers extracted from plants, agricultural and forest, and biomass, such as polysaccharides and derivatives thereof (e.g., gums, cellulose, cellulose esters, chitin, chitosan, starch, chemically modified starch, particles of cellulose acetate), proteins (e.g., zein, whey, gluten, collagen), lipids, lignins, and natural rubber; thermoplastic starch produced from starch or chemically starch and current polymers derived from naturally sourced monomers and derivatives, such as bio-polyethylene, bio-polypropylene, polytrimethylene terephthalate, polylactic acid, NYLON 11, alkyd resins, succinic acid-based polyesters, and bio-polyethylene terephthalate.

The suitable thermoplastic materials may include a blend or blends of different thermoplastic materials such in the examples cited above. As well the different materials may be a combination of materials derived from virgin bio-derived or petroleum-derived materials, or recycled materials of bio-derived or petroleum-derived materials. One or more of the thermoplastic materials in a blend may be biodegradable. And for non-blend thermoplastic materials, the thermoplastic material may be biodegradable.

The molten thermoplastic material described herein may have a viscosity, as defined by the melt flow index (MFI), of about 0.1 g/10 min to about 500 g/10 min, as measured by ASTM D1238 performed at temperature of about 230° C. with an about 2.16 kg weight. For example, for polypropylene the melt flow index can be in a range of about 0.5 g/10 min to about 200 g/10 min. Other suitable melt flow indexes include about 1 g/10 min to about 400 g/10 min, about 10 g/10 min to about 300 g/10 min, about 20 to about 200 g/10 min, about 30 g/10 min to about 100 g/10 min, about 50 g/10 min to about 75 g/10 min, about 0.1 g/10 min to about 1 g/10 min, or about 1 g/10 min to about 25 g/10 min. The MFI of the material is selected based on the application and use of the molded article. For examples, thermoplastic materials with an MFI of about 0.1 g/10 min to about 5 g/10 min may be suitable for use as preforms for ISBM applications. Thermoplastic materials with an MFI of about 5 g/10 min to about 50 g/10 min may be suitable for use as caps and closures for packaging articles. Thermoplastic materials with an MFI of 50 g/10 min to about 150 g/10 min may be suitable for use in the manufacture of buckets or tubs. Thermoplastic materials with an MFI of 150 g/10 min to about 500 g/10 min may be suitable for molded articles that have extremely high L/T ratios such as a thin plate. Manufacturers of such thermoplastic materials generally teach that the materials should be injection molded using relatively high melt pressures. Contrary to conventional teachings regarding injection molding of such thermoplastic materials, embodiments of the substantially constant low injection pressure molding method and device of the disclosure advantageously allow for forming quality injection molded parts using such thermoplastic materials and processing at low melt pressures.

Exemplary thermoplastic resins together with their recommended operating pressure ranges are provided in the following table (all numerical values provided in the following table may be preceded with the term “about”):

| | | Injection | | |
|---|---|---|---|---|
| | | Pressure Range | | Material Brand |
| Material | Full Name | (PSI) | Company | Name |
| Pp | Polypropylene | 10000-15000 | RTP Imagineering | RTP 100 series |
| | | | Plastics | Polypropylene |
| Nylon | | 10000-18000 | RTP Imagineering | RTP 200 series Nylon |
| | | | Plastics | |
| ABS | Acrylonitrile | 8000-20000 | Marplex | Astalac ABS |
| | Butadiene | | | |
| | Styrene | | | |
| PET | Polyester | 5800-14500 | Asia International | AIE PET 401F |
| Acetal | | 7000-17000 | API Kolon | Kocetal |
| Copolymer | | | | |
| PC | Polycarbonate | 10000-15000 | RTP Imagineering | RTP 300 series |
| | | | Plastics | Polycarbonate |
| PS | Polystyrene | 10000-15000 | RTP Imagineering | RTP 400 series |
| | | | Plastics | |
| SAN | Styrene | 10000-15000 | RTP Imagineering | RTP 500 series |
| | Acrylonitrile | | Plastics | |
| PE | LDPE & HDPE | 10000-15000 | RTP Imagineering | RTP 700 Series |
| | | | Plastics | |
| TPE | Thermoplastic | 10000-15000 | RTP Imagineering | RTP 1500 series |
| | Elastomer | | Plastics | |
| PVDF | Polyvinylidene | 10000-15000 | RTP Imagineering | RTP 3300 series |
| | Fluoride | | Plastics | |
| PTI | Polytrimethylene | 10000-15000 | RTP Imagineering | RTP 4700 series |
| | Terephthalate | | Plastics | |
| PBT | Polybutylene | 10000-15000 | RTP Imagineering | RTP 1000 series |
| | Terephthalate | | Plastics | |
| PLA | Polylactic Acid | 8000-15000 | RTP Imagineering | RTP 2099 series |
| | | | Plastics | |

While more than one of the embodiments involves filling substantially the entire mold cavity with the shot comprising the molten thermoplastic material while maintaining the melt pressure of the shot comprising the molten thermoplastic material at a substantially constant pressure, specific thermoplastic materials benefit from the disclosure at different constant pressures. Specifically: PP, nylon, PC, PS, SAN, PE, TPE, PVDF, PTI, PBT, and PLA at a substantially constant pressure of less than about 10,000 psi; ABS at a substantially constant pressure of less than about 8,000 psi; PET at a substantially constant pressure of less than 5,800 psi; Acetal copolymer at a substantially constant pressure of less than about 7,000 psi; plus poly(ethylene furanate) polyhydroxyalkanoate, polyethylene furanoate (aka PEF) at substantially constant pressure of less than about 10,000 psi, or about 8,000 psi, or about 7,000 psi or about 6,000 psi, or about 5,800 psi.

Thermoplastic polymers generally have higher molecular weights, which correspond to higher viscosities and lower melt flow rates at a given temperature. In some cases, these lower melt flow rates can result in lower manufacturing output and can make large-scale commercial production prohibitive. To increase melt flow, the extruder temperature and/or pressure can be increased, but this often leads to uneven shear stress, inconsistent melt flow, bubble instability, sticking or slippage of materials, and/or non-uniform material strain throughout the extruder, resulting in poor quality extrudate having irregularities, deformations, and distortions that can even cause the extrudate to break upon exiting. Further, high temperatures can potentially burn the thermoplastic melt, and excessive pressures can breach the extruder's structural integrity, causing it to rupture, leak, or crack. Some or all of these problems can be problematic for the injection stage of the IBM process. Alternatively, viscosity modifying additives such as diluents can be included in the formulation to help increase melt flow, reduce viscosity, and/or even out the shear stress. Many of these additives tend to migrate to the polymer's surface, resulting in a bloom that can render the thermoplastic unacceptable for its intended use. For example, diluent migration can make the thermoplastic article look or feel greasy, contaminate other materials it contacts, interfere with adhesion, and/or make further processing such as heat sealing or surface printing problematic. The effect may depend upon the type and percent included in the composition. A non-migrating additive can also be used, such as HCO.

Additives may be included in the thermoplastic materials. For example, blend additives, including viscosity modifiers may be included. For example, the resin composition can include a mixture, blend or an intimate admixture of a wax having a melting point greater than about 25° C., comprising about 0.1% to 50 wt % wax or about 5 wt % to about 40 wt % of the wax, based upon the total weight of the composition or about 8 wt % to about 30 wt % of the wax, based upon the total weight of the composition or about 10 wt % to about 20 wt % of the wax, based upon the total weight of the composition.

The wax may comprise a lipid, examples of which are a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, or combinations thereof. In other embodiments, the wax may comprise a mineral wax examples of which are a linear alkane, a branched alkane, or combinations thereof. The wax may comprise a wax which is selected from the group consisting of hydrogenated soy bean oil, partially hydrogenated soy bean oil, epoxidized soy bean oil, maleated soy bean oil, tristearin, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, 1,2-dipalmitolinolein, 1,2-distearo-olein, 1,3-distearo-olein, trimyristin, trilaurin, capric acid, caproic acid, caprylic acid, lauric acid, myristic acid, palmitic acid, stearic acid, and combinations thereof. The wax may comprise a wax is selected from the group consisting of a hydrogenated plant oil, a partially hydrogenated plant oil, an epoxidized plant oil, a maleated plant oil, and combinations thereof, wherein the plant oil may soy bean oil, corn oil, canola oil, palm kernel oil, or a combination thereof.

In other embodiments, oils or waxes may be selected from the group consisting of soy bean oil, epoxidized soy bean oil, maleated soy bean oil, corn oil, cottonseed oil, canola oil, beef tallow, castor oil, coconut oil, coconut seed oil, corn germ oil, fish oil, linseed oil, olive oil, oiticica oil, palm kernel oil, palm oil, palm seed oil, peanut oil, rapeseed oil, safflower oil, sperm oil, sunflower seed oil, tall oil, tung oil, whale oil, tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin, capric acid, caproic acid, caprylic acid, lauric acid, lauroleic acid, linoleic acid, linolenic acid, myristic acid, myristoleic acid, oleic acid, palmitic acid, palmitoleic acid, stearic acid, and combinations thereof.

The wax or oil may be dispersed within the thermoplastic polymer such that the wax or oil has a droplet size of less than about 10 μm within the thermoplastic polymer or wherein the droplet size is less than about 5 μm or wherein the droplet size is less than about 1 μm, or wherein the droplet size is less than about 500 nm.

The composition may further comprise an additive, wherein the additive is wax or oil soluble or wax or oil dispersible. The additive may be a perfume, dye, pigment, surfactant, nanoparticle, antistatic agent, filler, nucleating agent, or combination thereof. These additives may be included even if a wax or oil is not incorporated into the composition. The wax or oil may be a renewable or sustainable material.

For example, the resin composition can include a mixture, blend or an intimate admixture of a thermoplastic starch having a melting point greater than about 25° C., comprising about 0.1% to about 90 wt % TPS or wax or about 10 wt % to about 80 wt % of the thermoplastic starch, based upon the total weight of the composition or about 20 wt % to about 40 wt %. The thermoplastic starch may comprise starch or a starch derivative and a plasticizer. In another embodiment, the plasticizer may comprise a polyol wherein the polyol is selected from the group consisting of mannitol, sorbitol, glycerin, and combinations thereof. The plasticizer may be selected from the group consisting of glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate, dimethyl sebacate, urea, pentaerythritol ethoxylate, sorbitol acetate, pentaerythritol acetate, ethylenebisformamide, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythriol, arabitol, adonitol, xylitol, mannitol, iditol, galactitol, allitol, malitol, formaide, N-methylformamide, dimethyl sulfoxide, an alkylamide, a polyglycerol having 2 to 10 repeating units, and combinations thereof.

The starch or starch derivative may be selected from the group consisting of starch, hydroxyethyl starch, hydroxypropyl starch, carboxymethylated starch, starch phosphate, starch acetate, a cationic starch, (2-hydroxy-3-trimethyl(ammoniumpropyl) starch chloride, a starch modified by acid, base, or enzyme hydrolysis, a starch modified by oxidation, and combinations thereof.

Hydrogenated castor oil (also called castor wax) is a triacylglycerol prepared from castor oil, a product of the castor bean, through controlled hydrogenation. HCO is characterized by poor insolubility in most materials, very narrow melting range, lubricity, and excellent pigment and dye dispersibility. Because it is plant-based, HCO is a 100% bio-based and recyclable material. A suitable commercially available grade of HCO is “HYDROGENATED CASTOR OIL” available from Alnoroil Company, Inc. (Valley Stream, N.Y.). The principle constituent of HCO is 12-hydroxystearin. HCO is unique among fatty materials, as it primarily consists of 18-carbon fatty acid chains that each have a secondary hydroxyl group. While other waxes are prone to migrating to the thermoplastic's surface, HCO is unique because it does not. While not wishing to be limited by theory, it is believed that HCO is non-migrating because each molecule contains multiple (typically 3) hydroxyl (—OH) groups, enabling strong intermolecular hydrogen bonding between HCO molecules. A hydrogen bond is a directional electrostatic attraction involving a hydrogen atom and an electronegative atom such as an oxygen, nitrogen, or fluorine. In an —OH group, the oxygen attracts the bonding electrons more than the attached hydrogen does creating a dipole with the oxygen having a partial negative charge and the hydrogen a partial positive charge. Two —OH groups can thus be Coulombically attracted to one another, with the positive end of one interacting with the negative end of the other. In the case of HCO, a hydrogen of the —OH group of any particular fatty acid chain can interact with another —OH group on a different molecule to form an intermolecular hydrogen bond. Because HCO has multiple hydroxyl groups, multiple intermolecular associations are possible creating an entangled “supramolecular” structure with higher cohesive forces than other lower molecular weight lipids. While stronger than other non-covalent bonding, this form of intermolecular association can still be readily broken, thus preserving the thermoplastic nature of the composition. The composition can comprise, based upon the total weight of the composition, from about 5 wt % to about 50 wt % HCO, or from about 10 to about 50%, or from about 15 to about 50%, or from about 20 to about 50%, or from about 30 to about 50% HCO. The HCO contemplated for use herein has a melting point greater than about 65° C.

The HCO can be dispersed within the thermoplastic polymer such that the HCO has a droplet size of less than about 10 μm, less than about 5 μm, less than about 1 μm, or less than about 500 nm within the thermoplastic polymer. As used herein, the HCO and the polymer form an “intimate admixture” when the HCO has a droplet size less than about 10 μm within the thermoplastic polymer. The analytical method for determining droplet size is set forth herein.

If one desires to determine the percentage of HCO present in an unknown polymer-HCO composition (e.g., in a product made by a third party), the amount of HCO can be determined via a gravimetric weight loss method. The solidified mixture is broken apart to produce a mixture of particles with the narrowest dimension no greater than 1 mm (i.e. the smallest dimension can be no larger than 1 mm), the mixture is weighed, and then placed into acetone at a ratio of 1 g of mixture per 100 g of acetone using a refluxing flask system. The acetone and pulverized mixture is heated at 60° C. for 20 hours. The solid sample is removed and air dried for 60 minutes and a final weight determined. The equation for calculating the weight percent HCO is:

$$weight \% HCO = \frac{[ \begin{matrix}initial weight of mixture - \\ final weight of mixture\end{matrix} ]}{[ initial weight of mixture ]} \times 100 \%$$

Other waxes or oils can optionally be included such as hydrogenated soy bean oil, partially hydrogenated soy bean oil, partially hydrogenated palm kernel oil, and combinations thereof. Inedible waxes from Jatropha and rapeseed oil can also be used. Furthermore, optional waxes can be selected from the group consisting of a hydrogenated plant oil, a partially hydrogenated plant oil, an epoxidized plant oil, a maleated plant oil, and combinations thereof. Specific examples of such plant oils include soy bean oil, corn oil, canola oil, and palm kernel oil.

Current injection blow molding processes use conventional injection molding process conditions and equipment. Such conventional conditions and equipment expose the resin to degradation conditions such as high shear or pressures, sometimes of a changing nature, and heat degradation due to high temperatures of processing the resin. Further, the transfer period between the injection molding and blow molding stages can subject a portion of the preform, or the entire preform, to prolonged elevated heat temperatures, which again can lead to degradation of the resin and its melt, along with the finished cooled properties. Extended time exposure of higher temperature heat may affect the non-blown part of the preform, subjecting the finished portion (e.g., fitments, threads, snap-on bosses and detents, etc.) to possible degradation. For example, the non-blown portion of the preform may experience conduction of heat by the resin itself from another portion of the part and/or heat exposure from use of a heated blowing gas.

This is especially concerning with an injection blow molding process as (i) the blow molding properties and finished part (e.g., thickness) may be compromised from intended first intermediary part stresses present, which cannot be relieved before the blow molding stage; and (ii) the non-blow molded portion of the part may suffer from property or micro-dimensions degradation (e.g., thread sharpness which could result in higher bottle closure leakage possibility). Injection molding at a substantially constant low injection pressure, as described herein, may improve the optical clarity and resist degradation of the resin, as the lower injection pressure may result in more uniform stresses within the preform and reduced crystallinity. The risk of degradation can further be reduced by use of one or more improvements in the injection molding stage which reduce the stress and/or time at elevated temperature by application one or more of the following improvements alone or in combination.

Referring to FIG. 12, the impact of material properties and geometry on the rate of heat transfer and thermal energy content may affect the methods and apparatuses described herein. The following equations will be discussed below:

Amount of thermal energy transferred:

Q=m×C×ΔT

Rate of thermal energy transfer for a simplified geometry:

$$\frac{Q}{t} = k \times A ( {T}_{1} {T}_{2} ) \div D$$

where: Q=amount of thermal energy transferred (Joules)

m=mass of the body through which thermal energy is transferred (grams)
T₁T₂=Temperature reading at either end of body through which thermal energy is transferred
ΔT=temperature change in a body of mass m (degrees Kelvin)

C=specific heat of material (J/g·° K)

K=coefficient of thermal conductivity (J/s·m·° K)

D=thickness of body through which thermal energy is transferred

A=area of body in contact with T₁T₂ through which thermal energy is transferred

t=time (secs)

In a simplified mold cavity with a cooling channel, for example, all sections may be assumed to be infinitely planar. The mold cavity has a first surface, where T₁ is measured, that is in contact with the thermoplastic material as the mold cavity is filled. The mold cavity has a second surface, where T₂ is measured, that is in contact with cooling fluid that flows through a cooling circuit. In a sample region of the mold, including a portion of the first surface in contact with the thermoplastic material and a portion of the second surface in contact with the cooling fluid, the mold has a thickness separating the first surface from the second surface. Using the formula for rate of thermal energy transfer for a simplified geometry provided above, in one example T₁ and T₂ are assumed to be constant, and therefore represented as ΔT.

If the thickness of the mold separating the first surface (in contact with the thermoplastic material) and the second surface (in contact with the cooling fluid), or variable D, is constant, the rate of thermal energy transfer, or Q/t, is linearly proportional to the coefficient of thermal conductivity, K. Therefore, if the original mold material is 420SS, and it is replaced with QC-10 material, the rate of thermal energy transfer is increased by a factor of (160/23)=6.96.

If, however, the current rate of thermal energy transfer is desired, changing the conductive material can be modified by 1) increasing the distance, or the thickness D, between the first surface and the second surface of the mold; 2) reducing ΔT by adjusting T₂, or the temperature of the second surface in contact with the cooling fluid; or 3) a combination of options 1 and 2. Increasing D may be advantageous as it may require less energy and time to machine the cooling channel, decreases the odds of breaching through to the mold cavity during machining, and may increase the amount of time before cooling channel corrosion and erosion causes it to breach into the part cavity. Reducing ΔT can be advantageous as coolant is usually chilled water. By reducing ΔT, less energy may be used for chilling coolant.

Another consideration is the impact of specific heat on the rate of temperature change. Changing mold materials not only results in a different coefficient of thermal conductivity K, but also a different specific heat (the amount of energy required to change the temperature of a unit mass of material by a unit degree). This may be of interest as sensors are sensitive to the amount of temperature change. Referring again to the equation:

Q=m×C×ΔT

Using the same geometry as above for studying the impact of K on the rate of thermal energy transfer, assume again the volume of material V is constant. Further assume the amount of thermal energy transferred Q is constant. The equation may be rearranged to be

$$Δ {T}_{1} = \frac{Q}{mC}$$

To calculate the impact of changing the mold material from 420SS to QC-10 and keeping the geometry constant, the densities of each material should be considered when considering the ratio of (ΔT for QC-10 material)/(ΔT for 420SS material). For brevity, the subscript 1 is substituted for 420SS and the subscript 2 for QC-10 in the following equations:

$$Δ {T}_{1} = \frac{Q}{{m}_{1} {C}_{1}}$$

$$Δ {T}_{2} = \frac{Q}{{m}_{2} {C}_{2}}$$

Where m₁=volume of conductive material (V)×Density₁ and m₂=V×Density₂. Using the formulae above,

$$\frac{Δ {T}_{2}}{Δ {T}_{1}} = \frac{Q / ( {m}_{2} {C}_{2} )}{Q / ( {m}_{1} {C}_{1} )}$$

If Q is held constant,

$$\frac{Δ {T}_{2}}{Δ {T}_{1}} = \frac{1 / ( {m}_{2} {C}_{2} )}{1 / ( {m}_{1} {C}_{1} )} = ( {m}_{1} {C}_{1} ) / ( {m}_{2} {C}_{2} )$$

Substituting in their respective masses,

$$\frac{Δ {T}_{2}}{Δ {T}_{1}} = \frac{V \times {Density}_{1} {C}_{1}}{V \times {Density}_{2} {C}_{2}}$$

If V is held constant, the formula is reduced to

$$\frac{Δ {T}_{2}}{Δ {T}_{1}} = \frac{{Density}_{1} {C}_{1}}{{Density}_{2} {C}_{2}}$$

Inserting the values for 420SS (material 1) and QC-10 (material 2), in this equation, the result is:

$$\frac{Δ {T}_{2}}{Δ {T}_{1}} = \frac{7.8 \times .46}{2.85 \times .879} = 1.43$$

This result means that for the same amount of thermal energy transferred, the rate of temperature increase in QC-10 will be 1.43 times that in 420SS. Factoring in the increased rate of Q/t for QC-10 (6.96), the rate of temperature increase in QC-10 will be 1.43×6.96=9.95 times than in 420SS. The following table includes additional values for materials:

| | PP | 420SS | QC-10 | MoldMAX HH |
|---|---|---|---|---|
| c | 1.8 J/g ° K | .46 | .879 | .418 |
| K | .1-.22 W/m ° K | 23 | 160 | 104 |
| Density | 0.9 g/cc | 7.8 | 2.85 | 8.36 |

### Preforms

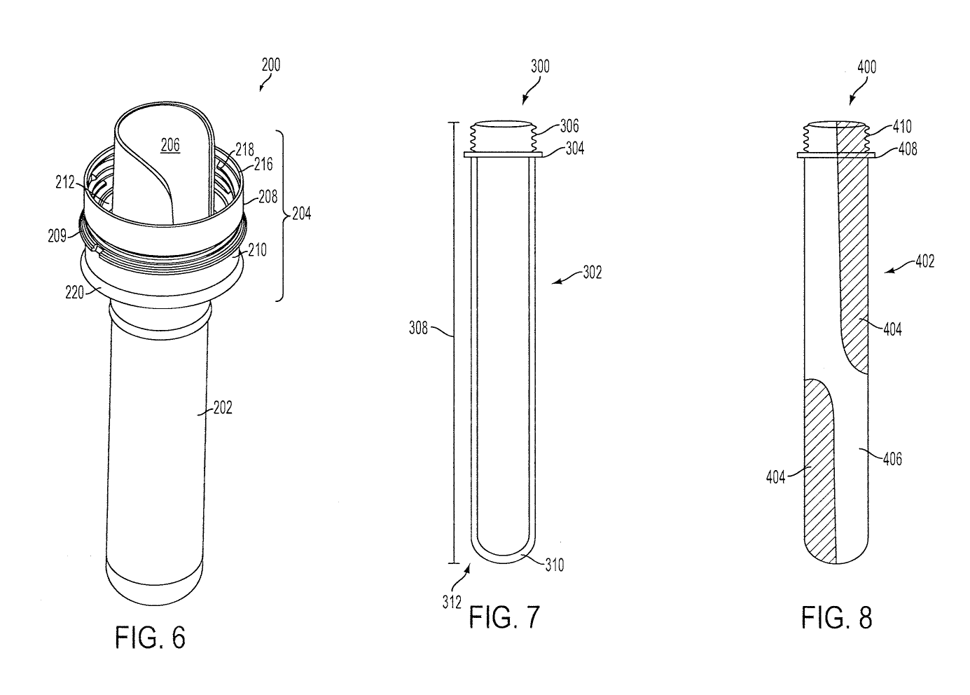

Referring now to FIGS. 6-8, exemplary preforms 200, 300, 400 are depicted. The preforms 200, 300, 400 are unfinished articles and are subject to a subsequent forming process, such as a blow molding operation. The quality of the preforms 200, 300, 400 directly affects and impacts the blow molding process and quality of the resulting plastic article. As discussed above, the preforms 200, 300, 400 may be formed using the injection molding process and the substantially constant low injection pressure injection molding apparatus 10 (shown in FIG. 1). Upon ejection from the substantially constant low injection pressure injection molding apparatus 10, the preforms 200, 300, 400 are moved from the injection molding stage to the blow molding stage, discussed in detail below.

Referring first to FIG. 6, the preform 200 has a tubular body 202 that is functionally connected to a head 204. During the blow molding process, the tubular body 202 expands into mold, forming the final shape of a resulting bottle, for example. In one embodiment, the shape of the head 204 remains substantially unchanged during the blow molding process. Such a configuration allows for precise molding of objects in the head that are not altered significantly by later blow molding processes. The preform 200 may include a neck 220 between the tubular body 202 and the head 204. The head 204 may include smooth portions 208, 210, separated by, for example, snap lock portion 209. The preform 200 may also include spout 206 and a complex feature 218 or multiple complex features. The complex feature 218 may be positioned at or near an end of the preform 200, as shown in FIG. 6. The complex feature 218 may be any one or combination of channeled threaded surfaces, channels fed away from a main flow path, and annular rings, or another feature.

Referring now to FIGS. 7 and 8, two additional embodiments of a preform 300, 400 created using the substantially constant low injection pressure method described herein are illustrated. Preform 300 includes a body 302, neck 304, and head 306 with complex features, or annular rings. The preform 300 has a length 308 and may be elongated by a stretch rod in a subsequent forming operation, such as a stretch blow molding operation. The preform 300 includes a lower portion 312 and a wall thickness 310. The wall thickness 310 may be uniform in certain predetermined portions. For example, the wall thickness 310 near the lower portion 312 of the preform 300 may be uniform and/or thicker than the wall thickness in other areas of the preform 300, which may help in creating a final plastic article with a thicker base for support, for example.

Referring now to FIG. 8, preform 400 is illustrated. Preform 400 is formed using the processes described above, and comprises two different materials 404, 406. Preform 400 may be formed by a multishot or co-injection injection process, for example, as discussed above in the injection molding stage section. Preform 400 includes neck 408 and head 410 with annular rings. To create preform 400, a first material 404 may be injected into a mold cavity to produce a first portion of the preform. The first portion of the preform may then be cooled to a temperature low enough to allow further mold operations without damaging or unintentionally modifying the first portion of the preform. After the first portion of the preform is cooled and sufficiently solid, the mold cavity shape is changed. A second material 406 can then be co-injected into the new cavity shape to make a second portion of the preform. The second material may be chemically distinct from the first material. The preform is made in such a way that the materials from the first and second injections are in direct contact with one another, allowing the materials to bond. Hence, the temperature of both portions of the preform is preferably sufficient to achieve bonding. The second material 406 to be injected can be the same material as the first material 404, or different. Alternatively two materials may be co-injected simultaneously into the first cavity during a co-injection technique. Using these techniques, a preform can be made wherein different materials can form different portions and/or layers of the preform.

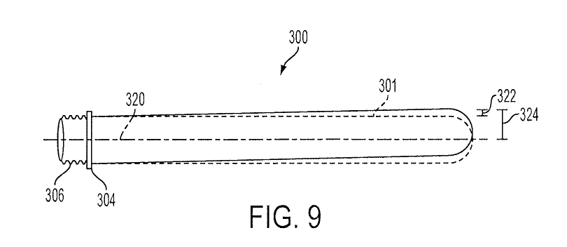

Referring now to FIG. 9, when preforms are cooled, there is a risk of introducing defects. For example, crystallinity and core shifting may occur. Core shifting is illustrated in FIG. 9, with preform 300 being illustrated. Upon completion of the injection process, preform 300 is formed and has intended central axis 320. However, preform 300 may only be supported at one end, thus forming a simply supported cantilevered beam, which makes the preform 300 subject to core shift. Core shifting occurs when the unsupported end of the preform 300 is deflected away from its intended central axis 320. This results in unintended non-uniform wall thickness around the preform 300, which can either negatively affect material distribution in the finished blown bottle, failures during blowing during a 2-step process due to uneven heating from non-uniform wall thickness, or require additional wall thickness be added to compensate to maintain a minimum wall thickness. Core shifting is illustrated with dashed line 301 representing the preform 300 after core shifting has occurred, with original distance 324 from the intended central axis 320 and deflection 322 being illustrated. Using the methods and apparatuses described herein, an unsupported end of the preform 300 may deflect away from the intended central axis 320, by a percentage of a total length of the preform, for example, a deflection of 0% to 10% of the total length of the preform, or any integer value for percentage between those values, or any range formed by any of those integer values. The methods and processes described herein may also reduce the likelihood of core shift. If there is core shift, its magnitude may be reduced roughly linearly to the reduction in injection pressure from conventional process control.

Crystallinity is another issue that may occur. For example, with PET preforms, if the preform is not cooled fast enough, crystallinity occurs, which may affect the clarity and/or opacity of the preform or the resulting blown article. Further, during cooling of the preform, stresses may be created and set within the preform which may affect the blow molding process. Observed stresses in preforms produced using the methods disclosed herein may be reduced compared to stresses observed in preforms produced using conventional methods.

The methods and apparatuses described herein allow for improved balanced heat removal from internal and external surfaces of the preform. The preforms produced using the apparatuses and methods described herein may further allow for improved cooling, due to the reduced thermal gradient between the thermoplastic material and the mold itself. The thermal conductivity of the injection mold allows for the thermoplastic material to be cooled more quickly, allowing for faster cycle time and may result in higher quality preforms. Upon forming the preform 300 and opening the mold, the preform may be cooled at a particular, controlled cooling rate selected such that a crystallinity of the preform is at least about 2% and at most about 8%. Additionally, because of the thermal conductivity of the mold, any cooling circuit or cooling fluid may be maintained at a higher temperature, reducing the load on any chillers required for temperature maintenance, thereby reducing manufacturing costs.

Increased mold temperature, and therefore a reduced temperature gradient between the mold temperature and the molten thermoplastic material also may result in reduced and more uniform stresses contained within the preform. The temperature gradient between the center of the preform and the walls of the preform may also be reduced. Additionally, improved cooling of the preform may result in more uniform internal and external stresses contained in preforms, as well as reduced and more uniform crystallinity. The substantially constant low injection pressure used to create the preforms reduces the stresses contained within the preform, which may prevent warping during subsequent blow molding operations. Reduced warpage may result in improved yields and a more consistent blow molding process. Further, the substantially constant low injection pressure injection molding process used to create preforms may improve consistency of preforms across a family of molds. For example, a preform formed in a first cavity may be substantially similar to a preform formed in a sixty-fourth cavity, particularly when compared to a high injection pressure injection molding process.

When the preforms produced according to the present disclosure are heated for the blow molding stage, any internal stresses may cause warpage or other defects. Increased uniformity of internal stresses may reduce the risk of warpage or other defects during the blow molding stage.

The methods and apparatuses described herein may further allow for consistently packing the mold so that at the end of fill region the injection pressure is similar to the injection pressure at the front of fill region. This may result in a reduced risk of overpacking the mold and reduced molded-in stresses in the preform. For a substantially amorphous PET preform, this can also lead to crystallinity at the gate resin due to overpacking. Additionally, part weight may be decreased, which may reduce costs associated with creating the preform.

Blow Molding Stage and Blow Molding Station

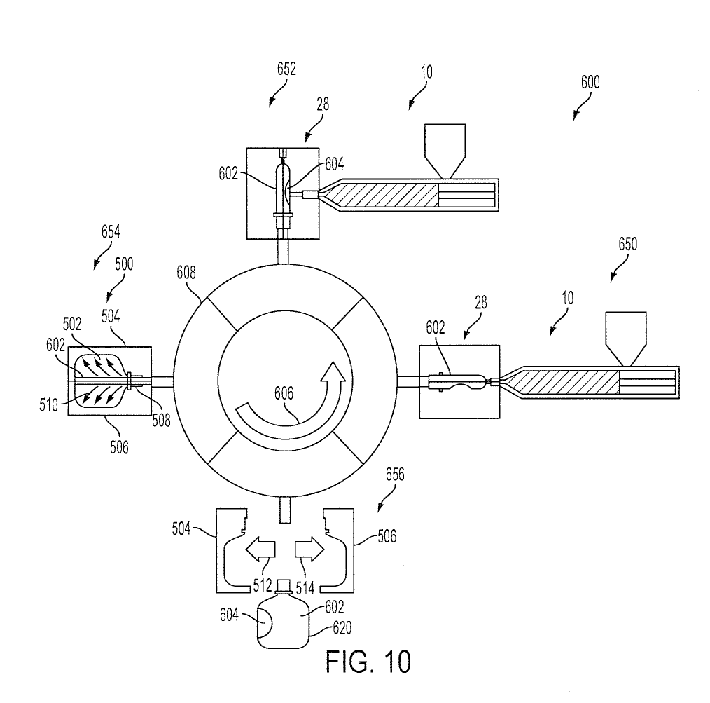

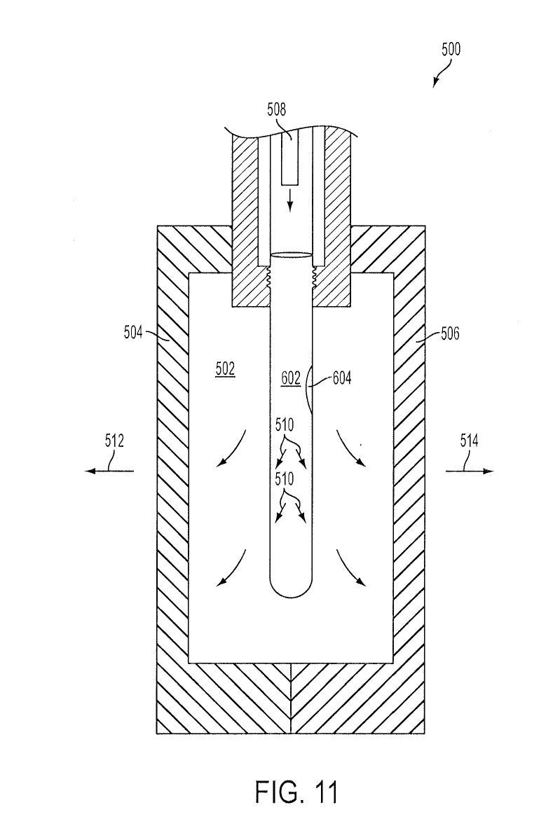

As discussed above, once the preform is formed, the preform may be transported to a blow molding apparatus 500 by an automated transport apparatus 608, such as a robotic arm, as illustrated in FIGS. 10 and 11. A preform 602 may be formed using the substantially constant low injection pressure apparatus 10 described above, in a first step 650. A first material may be injected into a mold cavity of mold 28. The partially formed preform 602 may then be transported in direction 606 to another injection molding station for a second injection step 652. A second material may be injected, forming a second portion 604 of the preform 602. The completed preform 602 may then be transported to a blow molding station 500 for a third step 654, shown in detail in FIG. 11.

The preform 602 may be loaded into the blow molding apparatus 500 and blow molded to form the final plastic article, for example bottle 620 (shown in FIG. 10). In the blow molding stage of the present method, the preform 602 is clamped in a blow molding cavity 502 formed from a first blow mold cavity portion 504 and a second blow mold cavity portion 506 and blow fluid is blown into the preform 602 with a fluid injection device, or blow pin 508 in this embodiment, to create a void volume. Examples of blow fluid include pressurized fluid, such as air, oxygen, nitrogen, carbon dioxide, or another fluid having similar gas properties. The preform 602 is blown by submitting the internal space thereof to pressure. The blow fluid is introduced through the blow pin 508, or, in some embodiments the core rod or mandrel. The blow pin 508 may first be inserted into the preform 602, and fluid may then be blown into the preform 300, or the process may occur simultaneously. The pressure, being omnidirectionally exerted as shown by arrows 510, causes the thermoplastic material to be forced outwardly, until the preform is expanded to substantially match the geometry of the blow molding cavity 502. A substantial match may occur when the preform is expanded to contact substantially all or substantially most of the blow mold cavity, for example. In some embodiments, the preform may be substantially symmetrically expanded, in that the preform expands omnidirectionally in equal amounts simultaneously, while in other embodiments, depending on the shape of the final plastic article, the preform may expand such that each wall of the final plastic article has a substantially uniform wall thickness.

Once the material of the preform 602 contacts the relatively cold walls of the blow molding cavity 502, the material may cool rapidly and solidify. The pressure applied has an influence on the uniformity and thickness of the material after the blowing stage is complete. High pressure may improve uniformity and encourage thin walls, but may also result in areas of no material and holes. A low pressure may result in a lack of uniformity, and not successfully covering the whole blow mold cavity with material. The pressure to be selected is dependent on the material used and the shape of the mold. In many of these situations, the preform produced with the improved injection stage provides more leeway during the blow molding stage, as the resin may be less degraded. In a fourth step 656, the first and second portions 504, 506 of the blow mold cavity 502 may then open in directions 512, 514 respectively and release the final plastic article 620.

In some embodiments, the preform may be cooled to a nominal ambient temperature before being transported to the blow molding apparatus 500. Cooling to a nominal ambient temperature may be achieved by a forced cooling apparatus, such as a blower configured to force air over and through the preform, contact with cooling surfaces, or by a quenching process configured to remove heat from the preform, for example. In some embodiments, the preform may be cooled to a specific temperature, such as about 120° C., or between about 100° C. and about 130° C. In other embodiments, the preform may be immediately transferred to the blow molding apparatus 500 while the preform retains heat from the injection molding stage. Further, the blow molding apparatus 500 may be directly attached to the substantially constant low injection pressure injection molding apparatus 10, or may be entirely detached from the substantially constant low injection pressure injection molding apparatus 10.

Following the injection molding stage and prior to the blow molding stage, the preform is optionally heated. Preferably the preform is reheated to a temperature suitable for blow molding. For example, PET preforms may be reheated to between about 90° C. to about 130° C. When reheating it is further preferred that the area of the preform to be blown is reheated uniformly. Preferably, the material of the preform to be blown is heated, whereas the collar, if present, may not be heated. Most preferably however, the area of the preform to be blown is maintained at a temperature suitable for blowing, while the collar is cooled to a point where it is hardened and no longer deformable. The benefit herein is that the collar is not damaged during blow molding of the remaining material.

In some embodiments, an optional stretching stage may be included using the blow molding apparatus, and a stretch rod may be included as part of the blow molding apparatus. In such an embodiment, the preform may be heated and then stretched into a more elongated geometry with the stretch rod. The stretch rod may stretch the preform to match the length of the blow molding cavity, for example. Exemplary stretch ratios include 1:9, 1:5, 1:3, 1:2, and 1:1.5 stretch ratios when comparing a final length of the stretched preform or final plastic article with the initial length of the preform. Embodiments that incorporate stretching steps are called injection stretch blow molding (ISBM) processes. The preform may be stretched concurrent to the blow molding process.

The method of the present disclosure may be achieved using any suitable equipment. In a preferred embodiment however, the method is achieved using equipment comprising at least one section thereof capable of rotating about an axis. Preferably the rotating section is capable of rotating at least 90° or alternatively 180°. A section of this kind described is also known as a turning-table. The purpose of this turning movement is to achieve multiple stages during a single molding cycle. In the present method, the mold is first aligned with the injection capability. Then once the injecting stage is complete and the preform is made, the mold or part thereof, comprising the preform, may be turned to coordinate with a blowing capability and the preform of the injection molding stage is blown in the blow molding stage. There can be a one or more additional stages during the single molding cycle, where the finished product is cooled and/or part removal such as by ejection. Other stages or stations can involve decoration of the part, inspection of the part, combination with other parts, or other purpose. These machines may be known as turntables as indicated above, index machines, or the like. Further, faster and lighter spinning or “cube” molds may be utilized with the present disclosure.

Alternatively, the turning movement of the molding unit can be performed outside the functional space where it connects with injection and blow molding capability. This can be realized through some kind of cassette system. Alternatively, the equipment may not comprise a turning-table, and instead the preliminary product and molding unit remain stationary and the injection capability is exchanged for blow-molding capability. Alternatively, in the present method, the mold is first aligned with the injection capability. Then once the injecting stage is complete and the preliminary product made, the mold or part thereof, comprising the preliminary product, may be transferred along a path, which may be linear, non-linear, with multiple direction changes, to coordinate with a blowing capability and the preliminary product of the 1^{st} stage is blown.

It is possible, and in some instances preferred, that the injection mold or particularly a part thereof, is also a part of the blow mold cavity during the blowing stage. This means that the preform will be blown against part of the injection mold, and/or against some of the preform, and against the blow mold cavity. In this way, one can substantially reduce the complexity of the blow mold, and reduce or eliminate the need for this blow mold to open in two halves in order to eject the product. This is because the split line between the injection half mold and blow mold can be done in such a way to eliminate or reduce any ‘undercut’ for the product against the blow mold cavity during the demolding operation, in case the blown cavity has a larger diameter than the neck itself. Once the plastic article is made, and after a suitable cooling, preferably to 50-60° C., the mold is opened so that the plastic article is ejected. The molding cycle can then be repeated.

As described in detail above, embodiments of the disclosed substantially constant low injection pressure molding method and device can achieve one or more advantages over conventional high variable pressure injection molding processes. For example, embodiments include a more cost effective and efficient process that eliminates the need to balance the pre-injection pressures of the mold cavity and the thermoplastic materials, a process that allows for use of atmospheric mold cavity pressures and, thus, simplified mold structures that eliminate the necessity of pressurizing means, the ability to use lower hardness, high thermal conductivity mold cavity materials that are more cost effective and easier to machine, a more robust processing method that is less sensitive to variations in the temperature, viscosity, and other material properties of the thermoplastic material, and the ability to produce quality injection molded parts at substantially constant pressures without premature hardening of the thermoplastic material in the mold cavity and without the need to heat or maintain constant temperatures in the mold cavity.

The disclosed substantially constant pressure injection molding machines advantageously reduce total cycle time for the molding process while increasing part quality. Moreover, the disclosed substantially constant pressure injection molding machines may employ, in some embodiments, electric presses, which are generally more energy efficient and require less maintenance than hydraulic presses. Additionally, the disclosed substantially constant pressure injection molding machines are capable of employing more flexible support structures and more adaptable delivery structures, such as wider platen widths, increased tie bar spacing, elimination of tie bars, lighter weight construction to facilitate faster movements, and non-naturally balanced feed systems. Thus, the disclosed substantially constant pressure injection molding machines may be modified to fit delivery needs and are more easily customizable for particular molded parts.

Additionally, the disclosed substantially constant pressure injection molding machines and methods allow the molds to be made from softer materials (e.g., materials having a Rc of less than about 30), which may have higher thermal conductivities (e.g., thermal conductivities greater than about 20 BTU/HR FT ° F.), which leads to molds with improved cooling capabilities and more uniform cooling. Because of the improved cooling capabilities, the disclosed substantially constant low injection pressure molds may include simplified cooling systems. Generally speaking, the simplified cooling systems include fewer cooling channels and the cooling channels that are included may be straighter, having fewer machining axes. One example of an injection mold having a simplified cooling system is disclosed in U.S. Patent Application No. 61/602,781, filed Feb. 24, 2012, which is hereby incorporated by reference herein.

The lower injection pressures of the substantially constant low injection pressure molding machines allow molds made of these softer materials to extract 1 million or more molding cycles, which would not be possible in conventional high variable pressure injection molding machines as these materials would fail before 1 million molding cycles in a high pressure injection molding machine.

It is noted that the terms “substantially,” “about,” and “approximately,” unless otherwise specified, may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Unless otherwise defined herein, the terms “substantially,” “about,” and “approximately” mean the quantitative comparison, value, measurement, or other representation may fall within 20% of the stated reference.

It should now be apparent that the various embodiments of the products illustrated and described herein may be produced by a low, substantially constant pressure molding process. While particular reference has been made herein to products for containing consumer goods or consumer goods products themselves, it should be apparent that the molding method discussed herein may be suitable for use in conjunction with products for use in the consumer goods industry, the food service industry, the transportation industry, the medical industry, the toy industry, and the like. Moreover, one skilled in the art will recognize the teachings disclosed herein may be used in the construction of stack molds, multiple material molds including rotational and core back molds, in combination with in-mold decoration, insert molding, in mold assembly, and the like.

All documents cited in the Detailed Description of the disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Experimental Results

A mold viscosity test was completed for a test mold, which was used to generate the data in the force vs. L/T chart below. This test determined the optimal injection rate was 6″ per second. An additional rate of 8″ per second was run to illustrate the relationship between injection rate and molding pressure. As mentioned above, the current industry practice is to inject at the maximum rate the molding press is capable of achieving. The data below illustrates that increasing injection rate leads to substantial increases in molding pressures, such as indicated by the 8″ per second data runs. Injecting at even faster rates such as 10″ per second, 20″ per second or faster, will lead to substantial increases in pressure. The test data is summarized in the tables below.

Data for Peak Power Flow Factor vs. L/T Graph

| | | | | | Peak Power | |
|---|---|---|---|---|---|---|
| | | | | Peak Power | Flow Factor | |
| | | | | Flow Factor | for New | |
| Material | Thickness | L/T | | @ 6 in/sec | Process | Graph Labels |
| | | | Peak Power | | | |
| | | | Flow Factor | | | |
| | | | @ 8 in/s | | | |
| 35 MFI | 2 | 62.5 | 420.15 | 360.53 | 6.15 | 35 MFI: PPFF @ 8 in/s Conventional |
| | 2 | 125 | 560.70 | 400.98 | 18.13 | 35 MFI: PPFF @ 6 in/s Conventional |
| | 2* | 185 | 534.29 | 397.56 | 82.71 | 35 MFI: PPFF New Process |
| | 2 | 240 | 568.47 | 404.40 | 130.28 | |
| 12 MFI | 2 | 62.5 | 733.61 | 526.84 | 22.82 | 12 MFI: PPFF @ 8 in/s Conventional |
| | 2 | 125 | 687.22 | 492.85 | 103.45 | 12 MFI: PPFF @ 6 in/s Conventional |
| | 2 | 185 | 675.69 | 518.06 | 136.84 | 12 MFI: PPFF New Process |
| | 2 | 240 | 703.58 | 528.70 | 159.89 | |
| 55 MFI | 2 | 62.5 | 444.59 | 291.68 | 7.61 | 55 MFI: PPFF @ 8 in/s Conventional |
| | 2 | 125 | 473.08 | 344.33 | 42.70 | 55 MFI: PPFF @ 6 in/s Conventional |
| | 2 | 185 | 490.32 | 353.19 | 62.25 | 55 MFI: PPFF New Process |
| | 2 | 240 | 547.91 | 377.98 | 43.60 | |
| | | | Values | | | |
| Reference | 2 | 62.5 | 157.25 | | | |
| Line | 2 | 125 | 223.89 | | | |
| | 2 | 185 | 245.02 | | | |
| | 2 | 240 | 268.93 | | | |

* The Peak Power Flow Factor data point for the New Process using the 35 MFI at a 185 L/T was calculated using the trendline equation (y = 1.0857 x − 80.383); where x = L/T value, and y = peak power flow rate.

Summary of Peak Volumetric Flow Rate Data

| | | | Volumetric | | Volumetric Flow |
|---|---|---|---|---|---|
| | | | Flow Rate | Volumetric Flow Rate | Rate (m³/s) for |
| Material | Thickness | L/T | (m³/s) @ 8 in/s | (m³/s) @ 6 in/s | New Process |
| 35 MFI | 2 | 62.5 | 9.160E−05 | 8.262E−05 | 4.967E−06 |
| | 2 | 125 | 1.167E−04 | 9.339E−05 | 1.610E−05 |
| | 2* | 185 | 1.185E−04 | 9.160E−05 | 3.719E−05 |
| | 2 | 240 | 1.185E−04 | 9.160E−05 | 7.671E−05 |
| 12 MFI | 2 | 62.5 | 1.042E−04 | 8.441E−05 | 1.038E−05 |
| | 2 | 125 | 1.131E−04 | 8.980E−05 | 3.791E−05 |
| | 2 | 185 | 1.149E−04 | 8.980E−05 | 4.300E−05 |
| | 2 | 240 | 1.167E−04 | 8.980E−05 | 6.725E−05 |
| 55 MFI | 2 | 62.5 | 1.006E−04 | 8.441E−05 | 8.360E−06 |
| | 2 | 125 | 1.167E−04 | 9.519E−05 | 3.327E−05 |
| | 2 | 185 | 1.203E−04 | 9.519E−05 | 4.959E−05 |
| | 2 | 240 | 1.203E−04 | 9.519E−05 | 4.669E−05 |

*The Volumetric Flow Rate data point for the New Process using the 35 MFI at a 185 L/T was calculated using the trendline equation (y = 2E−06e0.0158x); where x = L/T value, and y = volumetric flow rate.

| Material | MFI |
|---|---|
| Braskem FPT350WV3 | 35 |
| Braskem FT120W2 | 12 |
| Flint Hills 5155 | 55 |

Injection Screw Data

| | |
|---|---|
| Screw Diameter (mm) | 30 |
| Injection Area (mm²) | 706.86 |
| Injection Area (in²) | 1.096 |

Conversion factors

1 in = 0.0254 m
1 mm = 0.03937 in
1 in³/s = 16.38706 cm³/s
1 psi = 6894.757 pa
1 Watt = 0.00134 hp

When comparing the peak flow rate and peak power levels required to mold an injection molded part, the melt temperatures and mold temperatures should be consistent between the conditions run for both the conventional and the constant pressure process. Furthermore, these temperature settings should are generally based on the recommended temperatures from the resin manufacturer or within suitable ranges to ensure the resin is processed as intended by the manufacturer.

Part, parts, or all of any of the embodiments disclosed herein can be combined with part, parts, or all of other injection molding embodiments known in the art, including those described below.

Embodiments of the present disclosure can be used with embodiments for injection molding at low constant pressure, as disclosed in U.S. patent application Ser. No. 13/476,045 filed May 21, 2012, entitled “Apparatus and Method for Injection Molding at Low Constant Pressure” (applicant's case 12127) and published as US 2012-0294963 A1, which is hereby incorporated by reference.

Embodiments of the present disclosure can be used with embodiments for pressure control, as disclosed in U.S. patent application Ser. No. 13/476,047 filed May 21, 2012, entitled “Alternative Pressure Control for a Low Constant Pressure Injection Molding Apparatus” (applicant's case 12128) and published as US 2012-0291885 A1, which is hereby incorporated by reference.

Embodiments of the present disclosure can be used with embodiments for non-naturally balanced feed systems, as disclosed in U.S. patent application Ser. No. 13/476,073 filed May 21, 2012, entitled “Non-Naturally Balanced Feed System for an Injection Molding Apparatus” (applicant's case 12130) and published as US 2012-0292823 A1, which is hereby incorporated by reference.

Embodiments of the present disclosure can be used with embodiments for injection molding at low, substantially constant pressure, as disclosed in U.S. patent application Ser. No. 13/476,197 filed May 21, 2012, entitled “Method for Injection Molding at Low, Substantially Constant Pressure” (applicant's case 12131Q) and published as US 2012-0295050 A1, which is hereby incorporated by reference.

Embodiments of the present disclosure can be used with embodiments for injection molding at low, substantially constant pressure, as disclosed in U.S. patent application Ser. No. 13/476,178 filed May 21, 2012, entitled “Method for Injection Molding at Low, Substantially Constant Pressure” (applicant's case 12132Q) and published as US 2012-0295049 A1, which is hereby incorporated by reference.

Embodiments of the present disclosure can be used with embodiments for co-injection processes, as disclosed in U.S. patent application Ser. No. 13/774,692 filed Feb. 22, 2013, entitled “High Thermal Conductivity Co-Injection Molding System” (applicant's case 12361), which is hereby incorporated by reference.

Embodiments of the present disclosure can be used with embodiments for molding with simplified cooling systems, as disclosed in U.S. patent application Ser. No. 13/765,428 filed Feb. 12, 2013, entitled “Injection Mold Having a Simplified Evaporative Cooling System or a Simplified Cooling System with Exotic Cooling Fluids” (applicant's case 12453M), now U.S. Pat. No. 8,591,219, which is hereby incorporated by reference.

Embodiments of the present disclosure can be used with embodiments for molding thinwall parts, as disclosed in U.S. patent application Ser. No. 13/476,584 filed May 21, 2012, entitled “Method and Apparatus for Substantially Constant Pressure Injection Molding of Thinwall Parts” (applicant's case 12487), which is hereby incorporated by reference.

Embodiments of the present disclosure can be used with embodiments for molding with a failsafe mechanism, as disclosed in U.S. patent application Ser. No. 13/672,246 filed Nov. 8, 2012, entitled “Injection Mold With Fail Safe Pressure Mechanism” (applicant's case 12657), which is hereby incorporated by reference.

Embodiments of the present disclosure can be used with embodiments for high-productivity molding, as disclosed in U.S. patent application Ser. No. 13/682,456 filed Nov. 20, 2012, entitled “Method for Operating a High Productivity Injection Molding Machine” (applicant's case 12673R), which is hereby incorporated by reference.

Embodiments of the present disclosure can be used with embodiments for molding certain thermoplastics, as disclosed in U.S. patent application Ser. No. 14/085,515 filed Nov. 20, 2013, entitled “Methods of Molding Compositions of Thermoplastic Polymer and Hydrogenated Castor Oil” (applicant's case 12674M), which is hereby incorporated by reference.

Embodiments of the present disclosure can be used with embodiments for runner systems, as disclosed in U.S. patent application Ser. No. 14/085,515 filed Nov. 21, 2013, entitled “Reduced Size Runner for an Injection Mold System” (applicant's case 12677M), which is hereby incorporated by reference.

Embodiments of the present disclosure can be used with embodiments for moving molding systems, as disclosed in U.S. patent application 61/822,661 filed May 13, 2013, entitled “Low Constant Pressure Injection Molding System with Variable Position Molding Cavities:” (applicant's case 12896P), which is hereby incorporated by reference.

Embodiments of the present disclosure can be used with embodiments for injection mold control systems, as disclosed in U.S. patent application 61/861,298 filed Aug. 20, 2013, entitled “Injection Molding Machines and Methods for Accounting for Changes in Material Properties During Injection Molding Runs” (applicant's case 13020P), which is hereby incorporated by reference.

Embodiments of the present disclosure can be used with embodiments for injection mold control systems, as disclosed in U.S. patent application 61/861,304 filed Aug. 20, 2013, entitled “Injection Molding Machines and Methods for Accounting for Changes in Material Properties During Injection Molding Runs” (applicant's case 13021P), which is hereby incorporated by reference.

Embodiments of the present disclosure can be used with embodiments for injection mold control systems, as disclosed in U.S. patent application 61/861,310 filed Aug. 20, 2013, entitled “Injection Molding Machines and Methods for Accounting for Changes in Material Properties During Injection Molding Runs” (applicant's case 13022P), which is hereby incorporated by reference.

Embodiments of the present disclosure can be used with embodiments for using injection molding to form overmolded articles, as disclosed in U.S. patent application 61/918,438 filed Dec. 19, 2013, entitled “Methods of Forming Overmolded Articles” (applicant's case 13190P), which is hereby incorporated by reference.

Embodiments of the present disclosure can be used with embodiments for controlling molding processes, as disclosed in U.S. Pat. No. 5,728,329 issued Mar. 17, 1998, entitled “Method and Apparatus for Injecting a Molten Material into a Mold Cavity” (applicant's case 12467CC), which is hereby incorporated by reference.

Embodiments of the present disclosure can be used with embodiments for controlling molding processes, as disclosed in U.S. Pat. No. 5,716,561 issued Feb. 10, 1998, entitled “Injection Control System” (applicant's case 12467CR), which is hereby incorporated by reference.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for forming a plastic article, the system comprising a preform injection molding apparatus for forming a preform, which is configured to be subjected to a subsequent forming process, the preform injection molding apparatus comprising a mold, a plastic melt injection system, a sensor, and a controller, wherein:
the mold has a first mold portion and a second mold portion;
the mold is configured to move from an open position, wherein the first mold portion and the second mold portion are separated, to a closed position, wherein the first mold portion and the second mold portion form a plurality of mold cavities;
the first mold portion is made of a material having a thermal conductivity between about 52 watts per meter kelvin and about 385 watts per meter kelvin;
the plastic melt injection system includes a melt holder configured to retain molten thermoplastic material and an injection element configured to inject the molten thermoplastic material into the mold cavities;
the sensor is configured to sense a characteristic of the molten thermoplastic material in the melt holder and to transmit to the controller, a signal from the sensor;
The controller is configured to control the injection element to maintain the molten thermoplastic material at a substantially constant melt pressure, during filling of the mold cavities, wherein the substantially constant melt pressure is between about 6.89 megapascals (1,000 psi) and about 103.42 megapascals (15,000 psi); and
the preform injection molding apparatus is designed to have a useful life of between one million and ten million injection molding cycles.

2. The system of claim 1, wherein the first mold portion is made of a material having a thermal conductivity between about 52 watts per meter kelvin and about 385 watts per meter kelvin.

3. The system of claim 1, wherein the first mold portion is made of a material having a thermal conductivity between about 60 watts per meter kelvin and about 346 watts per meter kelvin.

4. The system of claim 1, wherein the first mold portion is made of a material having a thermal conductivity between about 69 watts per meter kelvin and about 329 watts per meter kelvin.

5. The system of claim 1, wherein the first mold portion is made of a material having a thermal conductivity between about 86 watts per meter kelvin and about 311 watts per meter kelvin.

6. The system of claim 1, wherein the first mold portion is made of a material having a thermal conductivity between about 130 watts per meter kelvin and about 259 watts per meter kelvin.

7. The system of claim 1, wherein the second mold portion is made of a material having a thermal conductivity between about 52 watts per meter kelvin and about 385 watts per meter kelvin.

8. The system of claim 1, wherein the first mold portion is made of an aluminum alloy.

9. The system of claim 1, wherein the first mold portion further comprises a cooling circuit configured to remove heat from the first mold portion.

10. The system of claim 2, wherein the second mold portion further comprises a cooling circuit configured to remove heat from the second mold portion.

11. The system of claim 1, further comprising a blow molding apparatus, which includes a plurality of blow mold cavities and a fluid injection device configured to inject fluid into the preform.

12. The system of claim 11, wherein the blow molding apparatus further comprises a stretch rod configured to stretch the preform into an elongated geometry with a stretch ratio between 1:1.5 and 1:3.

13. The system of claim 11, wherein the preform injection molding apparatus is separate from the blow molding apparatus.

14. The system of claim 13, which further comprising an automated transfer apparatus, which is configured to automatically transfer the preform from the perform injection molding apparatus to the blow molding apparatus.

15. The system of claim 1, wherein the controller is configured to control the injection element to maintain the molten thermoplastic material at the substantially constant melt pressure, during the filling of the mold cavities, wherein the substantially constant melt pressure is between about 6.89 megapascals (1,000 psi) and about 82.74 megapascals (12,000 psi).

16. The system of claim 1, wherein the controller is configured to control the injection element to maintain the molten thermoplastic material at the substantially constant melt pressure, during the filling of the mold cavities, wherein the substantially constant melt pressure is between about 6.89 megapascals (1,000 psi) and about 68.95 megapascals (10,000 psi).

17. The system of claim 1, wherein the preform injection molding apparatus is designed to have a useful life of between one million and five million injection molding cycles.

18. The system of claim 1, wherein the preform injection molding apparatus is designed to have a useful life of between one million and two million injection molding cycles.

19. The system of claim 1, wherein the preform injection molding apparatus is designed to have a useful life of between two million and ten million injection molding cycles.

20. The system of claim 1, wherein the preform injection molding apparatus is designed to have a useful life of between five million and ten million injection molding cycles.
